(19) United States
(12) Patent Application Publication
(10) Pub. No.: US 2024/0359104 A1
(43) Pub. Date: Oct. 31, 2024

(54) STORAGE MEDIUM, GAME SYSTEM, GAME APPARATUS, AND GAME PROCESSING METHOD

(71) Applicant: NINTENDO CO., LTD., Kyoto (JP)

(72) Inventors: Corey Michael BUNNELL, Kyoto (JP); Atsushi ASAKURA, Kyoto (JP)

(21) Appl. No.: 18/624,565

(22) Filed: Apr. 2, 2024

(30) Foreign Application Priority Data
Apr. 27, 2023 (JP) 2023-073640

(51) Int. Cl. A63F 13/58; A63F 13/69

(52) U.S. Cl. CPC A63F 13/58; A63F 13/69

(57) ABSTRACT

At least one attack is generated in a virtual space, and an ID is assigned to each attack, based on a game process. When the attack hits an object in the virtual space, it is determined that the attack is successful, and a damage caused by the attack is calculated. When an attack having an ID that is the same as the ID assigned to a past attack that has hit an object hits the object, damage is caused due to the attack having the same ID.

### CROSS REFERENCE TO RELATED APPLICATIONS

This application claims priority to Japanese Patent Application No. 2023-073640, filed on Apr. 27, 2023, the entire contents of which are incorporated herein by reference.

### FIELD

The technology disclosed herein relates to a storage medium, game system, game apparatus, and game processing method that execute a process using a character in a virtual space.

### BACKGROUND AND SUMMARY

There has been conventionally a game system that carries out a game in which a plurality of characters fight with each other using a weapon such as a sword in a virtual space.

However, in such a game system, if, when a plurality of attacks occur, damage calculation is calculated for each attack, an unrealistic impression is likely to be given to the user.

With the above in mind, it is an object of the present example to provide a non-transitory computer-readable storage medium, game system, game apparatus, and game processing method in which when a plurality of attacks occur in a virtual space, damage calculation can be performed based on the attacks.

To achieve the object, the present example may have features (1) to (7) below, for example.

(1) An example configuration of a non-transitory computer-readable storage medium of the present example has stored therein instructions that, when executed, cause one or more processors of an information processing apparatus to execute game processing comprising: executing an attack generation process of generating at least one attack in a virtual space, and assigning an ID to each attack, based on a game process; and when the attack hits an object in the virtual space, determining that the attack is successful, and executing a damage calculation process of calculating damage caused by the attack. In the damage calculation process, when an attack having an ID that is the same as the ID assigned to a past attack that has hit the object hits the object, damage is caused due to the attack having the same ID.

With the configuration of (1), the same ID that is assigned to a past attack that has hit an object is assigned to the current attack that hits the object. Therefore, the case in which after it is determined that the past attack is successful and damage is caused, damage due to the current attack is not caused to occur, can be avoided. As a result, the user is less likely to have unrealistic impression when a series of successive attacks occur.

(2) In the configuration of (1), in the damage calculation process, when an attack having an ID that is different from the ID assigned to a past attack that has hit the object due to the attack hits the object, damage due to the attack having the different ID may be forbidden to occur during a period of time from the past attack, and when an attack having an ID that is the same as the ID assigned to a past attack that has hit the object due to the attack hits the object during the period of time, damage may be caused due to the attack having the same ID.

With the configuration of (2), even during an invincibility period that damage due to an attack is not caused to an object, an attack having the same ID that is assigned to a past attack that has hit the object causes damage to the object. Therefore, a series of successive attacks may be considered as a single attack group. As a result, the user is less likely to have unrealistic impression.

(3) In the configuration of (1) or (2), the game processing may further comprise: executing a character control process of controlling a character that is the object in the virtual space. In the damage calculation process, in an attack that is against the character and has an ID that is the same as the ID assigned to a past attack that it is determined that the character has successfully defended itself against using a defensive object with which the character is equipped, damage to the character due to the attack having the same ID may be forbidden to occur.

With the configuration of (3), when the defense of an object against a past attack was successful and damage was not caused to the object, damage due to a current attack can also be avoided for the object. As a result, the user is less likely to have unrealistic impression when a series of successive attacks occur.

(4) In the configuration of any one of (1) to (3), the game processing may further comprise: executing a character control process of controlling a character that is the object equipped with a defensive object having a durability value that is reduced each time defense is successful against the attack in the virtual space. In the character control process, when an attack having an ID that is the same as the ID assigned to a past attack that it is determined that the character has successfully defended itself against using the defensive object and that has reduced the durability value hits the defensive object, a reduction in the durability value due to the attack having the same ID may be forbidden to occur.

With the configuration of (4), when defense against a past attack using a defensive object is successful and the durability value of the defensive object is reduced, a reduction in the durability value of the defensive object due to a current attack can be avoided. Therefore, the use is less likely to have unrealistic impression that the durability value of a defensive object is quickly reduced, so that the defensive object is easily broken.

(5) In the configuration of any one of (1) to (4), the game processing may further comprise: executing a character control process of controlling a character in the virtual space. In the attack generation process, when the character is caused to perform the attack using a combination weapon object obtained by combining a weapon object with an item object, in the attack an attack using the weapon object and an attack using the item object may be generated, and the same ID may be assigned to the attack using the weapon object and the attack using the item object. In the damage calculation process, when it is determined that one of the attack using the weapon object and the attack using the item object is successful, and damage is caused to the object due to the one attack, damage may be further caused due to the other of the attack using the weapon object and the attack using the item object.

With the configuration of (5), when a plurality of attacks are generated by a single attack using a combination weapon object, then if one of an attack using a weapon object and an attack using an item object is successful and causes damage to an object, the other of the attack using the weapon object and the attack using the item object also causes damage to the object. As a result, the user is less likely to have unrealistic impression that only one of an attack using a weapon object and an attack using an item object causes damage.

(6) In the configuration of any one of (1) to (5), in the attack generation process, a series of attacks that are a first attack, a second attack, and a third attack may be generated according to a user's attack command input, a first ID may be assigned to the first attack according to the attack command input, a second ID that is the same as the first ID may be assigned to the second attack associated with the first attack at the time of the first attack or after the first attack occurs, and a third ID that is the same as the second ID may be assigned to the third attack associated with the second attack after the first attack occurs, at the time of the second attack, or after the second attack occurs. In the damage calculation process, when the attack having the first ID and/or the attack having the second ID hit the object, damage may be caused due to the attack having the third ID.

With the configuration of (6), when a series of three attacks (first to third attacks) occur, then if the same ID is assigned to each attack, the case in which after the first attack is determined to be successful and causes damage, damage is not caused due to the third attack, can be avoided, for example. As a result, the user is less likely to have unrealistic impression when a series of three attacks occur.

(7) Another example configuration of a non-transitory computer-readable storage medium of the present example has stored therein instructions that, when executed, cause one or more processors of an information processing apparatus to execute game processing comprising: executing a character control process of controlling a character in a virtual space; executing an attack generation process of causing the character to perform an attack using a weapon object that the character is allowed to carry; and when the attack hits an object disposed in the virtual space, determining that the attack is successful, and executing a damage calculation process of calculating damage caused by the attack. In the attack generation process, when the character is caused to perform the attack using a combination weapon object obtained by combining the weapon object with an item object, in the attack an attack using the weapon object and an attack using the item object are generated. In the damage calculation process, when it is determined that one of the attack using the weapon object and the attack using the item object is successful, and damage is caused to the object due to the one attack, damage is further caused due to the other of the attack using the weapon object and the attack using the item object.

With the configuration of (7), when a plurality of attacks are generated by a single attack using a combination weapon object, then if one of an attack using a weapon object and an attack using an item object hits an object and causes damage to an object, the other of the attack using the weapon object and the attack using the item object also hits the object and causes damage to the object. As a result, the user is less likely to have unrealistic impression that only one of an attack using a weapon object and an attack using an item object causes damage.

The present example may also be carried out in the form of a game system, game apparatus, and game processing method.

According to the present example, the case can be avoided in which when a plurality of attacks are performed against an object, then if one of the attacks hits the object and is determined to be successful, and causes damage to the object, damage due to the other attacks is not caused. Therefore, the user is less likely to have unrealistic impression when a plurality of attacks occur.

These and other objects, features, aspects and advantages of the present exemplary embodiment will become more apparent from the following detailed description of the present exemplary embodiment when taken in conjunction with the accompanying drawings.

### BRIEF DESCRIPTION OF THE DRAWINGS

FIG. 1 is a diagram illustrating a non-limiting example of a state in which a left controller 3 and a right controller 4 are attached to a main body apparatus 2,

FIG. 2 is a diagram illustrating a non-limiting example of a state in which a left controller 3 and a right controller 4 are detached from a main body apparatus 2,

FIG. 3 illustrates six orthogonal views of a non-limiting example of a main body apparatus 2,

FIG. 4 illustrates six orthogonal views of a non-limiting example of a left controller 3,

FIG. 5 illustrates six orthogonal views of a non-limiting example of a right controller 4,

FIG. 6 is a block diagram illustrating a non-limiting example of an internal configuration of a main body apparatus 2,

FIG. 7 is a block diagram illustrating non-limiting examples of internal configurations of a main body apparatus 2, a left controller 3, and a right controller 4,

FIG. 8 is a diagram illustrating a non-limiting example of a game image showing a scene in which a player object PO attacks an opponent object EO using a weapon object A in a virtual space,

FIG. 9 is a diagram illustrating a non-limiting example of a game image showing a scene in which a player object PO synthesizes a combination weapon object α in a virtual space,

FIG. 10 is a diagram illustrating a non-limiting example of a relationship between a weapon object, an item object, a combination weapon object generated based on these objects, and the effect of an attack using the combination weapon object,

FIG. 11 is a diagram illustrating a non-limiting example of a game image of a first stage in which a player object PO attacks an opponent object EO using a combination weapon object α in a virtual space,

FIG. 12 is a diagram illustrating a non-limiting example of a game image of a second stage in which a player object PO attacks an opponent object EO using a combination weapon object α in a virtual space,

FIG. 13 is a diagram illustrating a non-limiting example of a game image of a third stage in which a player object PO attacks an opponent object EO using a combination weapon object α in a virtual space,

FIG. 14 is a diagram illustrating a non-limiting example of a game image of a first stage in which an opponent object EO defends itself, using a defensive object E, against an attack from a player object PO using a combination weapon object α in a virtual space,

FIG. 15 is a diagram illustrating a non-limiting example of a game image of a second stage in which an opponent object EO defends itself, using a defensive object E, against an attack from a player object PO using a combination weapon object α in a virtual space,

FIG. 16 is a diagram illustrating a non-limiting example of a game image showing a scene in which a player object PO is under a lightning attack in a virtual space,

FIG. 17 is a diagram illustrating a non-limiting example of a data area set in a DRAM 85 of a main body apparatus 2,

FIG. 18 is a flowchart illustrating a non-limiting example of a game process that is executed in the game system 1,

FIG. 19 is a subroutine illustrating a non-limiting example of an attack generation process in step S124 of FIG. 18, and

FIG. 20 is a subroutine illustrating a non-limiting example of a damage calculation process in step S125 of FIG. 18.

### DETAILED DESCRIPTION OF NON-LIMITING EXAMPLE EMBODIMENTS

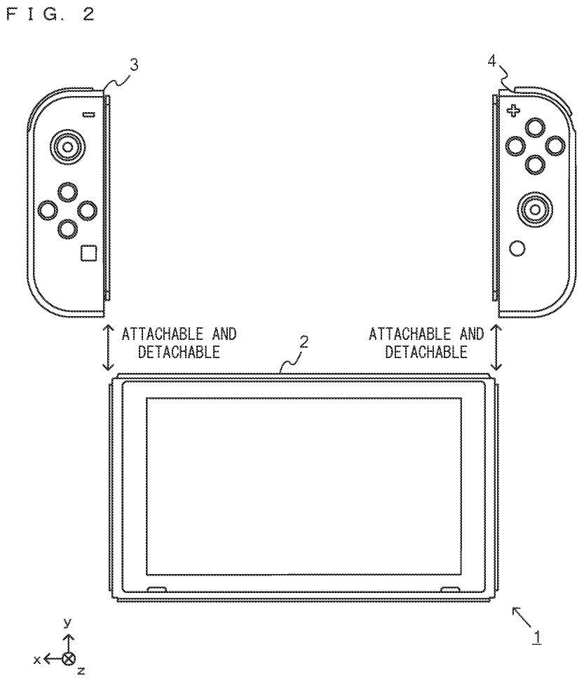

A game system according to the present example will now be described. An example of a game system 1 according to the present example includes a main body apparatus (information processing apparatus serving as the main body of a game apparatus in the present example) 2, a left controller 3, and a right controller 4. The left controller 3 and the right controller 4 are attachable to and detachable from the main body apparatus 2. That is, the user can attach the left controller 3 and the right controller 4 to the main body apparatus 2, and use them as a unified apparatus. The user can also use the main body apparatus 2 and the left controller 3 and the right controller 4 separately from each other (see FIG. 2). In the description that follows, a hardware configuration of the game system 1 of the present example is described, and thereafter, the control of the game system 1 of the present example is described.

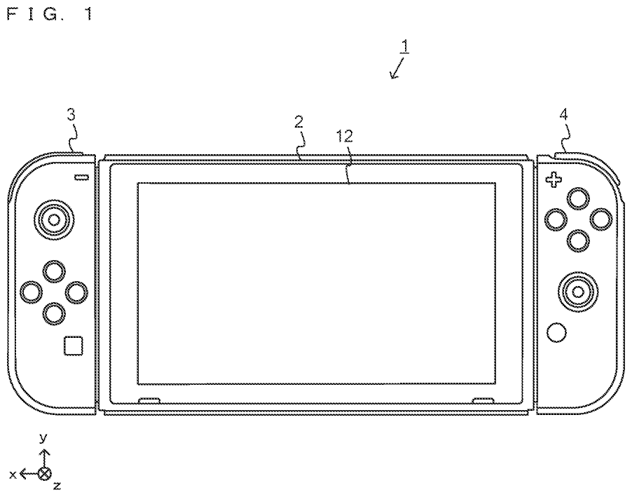

FIG. 1 is a diagram illustrating an example of a state in which the left controller 3 and the right controller 4 are attached to the main body apparatus 2. As illustrated in FIG. 1, each of the left controller 3 and the right controller 4 is attached to and unified with the main body apparatus 2. The main body apparatus 2 is an apparatus for performing various processes (e.g., game processing) in the game system 1. The main body apparatus 2 includes a display 12. Each of the left controller 3 and the right controller 4 is an apparatus including operation sections with which a user provides inputs.

FIG. 2 is a diagram illustrating an example of a state in which each of the left controller 3 and the right controller 4 is detached from the main body apparatus 2. As illustrated in FIGS. 1 and 2, the left controller 3 and the right controller 4 are attachable to and detachable from the main body apparatus 2. It should be noted that hereinafter, the left controller 3 and the right controller 4 will occasionally be referred to collectively as a “controller”.

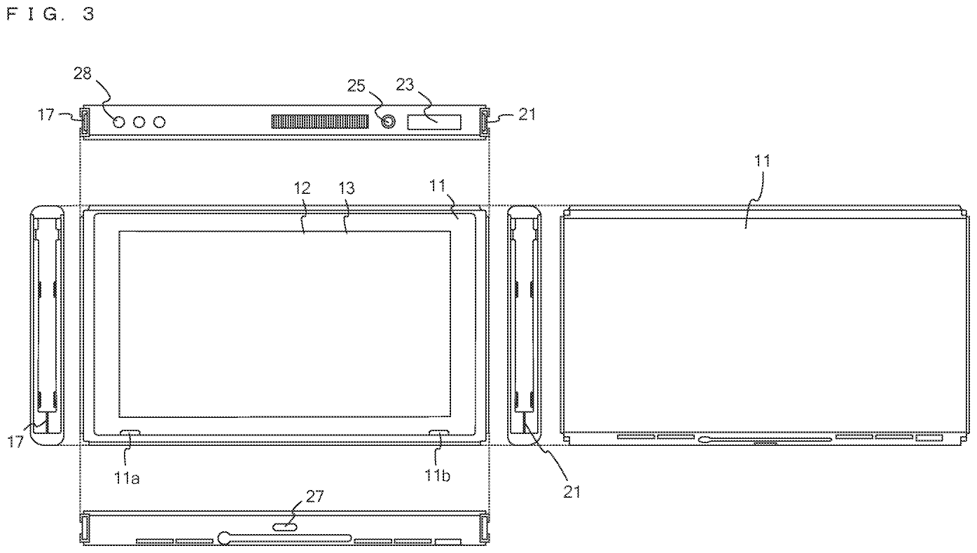

FIG. 3 illustrates six orthogonal views of an example of the main body apparatus 2. As illustrated in FIG. 3, the main body apparatus 2 includes an approximately plate-shaped housing 11. In the present example, a main surface (in other words, a surface on a front side, i.e., a surface on which the display 12 is provided) of the housing 11 has a generally rectangular shape.

It should be noted that the shape and the size of the housing 11 are optional. As an example, the housing 11 may be of a portable size. Further, the main body apparatus 2 alone or the unified apparatus obtained by attaching the left controller 3 and the right controller 4 to the main body apparatus 2 may function as a mobile apparatus. The main body apparatus 2 or the unified apparatus may function as a handheld apparatus or a portable apparatus.

As illustrated in FIG. 3, the main body apparatus 2 includes the display 12, which is provided on the main surface of the housing 11. The display 12 displays an image generated by the main body apparatus 2. In the present example, the display 12 is a liquid crystal display device (LCD). The display 12, however, may be a display device of any suitable type.

In addition, the main body apparatus 2 includes a touch panel 13 on the screen of the display 12. In the present example, the touch panel 13 allows multi-touch input (e.g., a capacitive touch panel). It should be noted that the touch panel 13 may be of any suitable type, e.g., it allows single-touch input (e.g., a resistive touch panel).

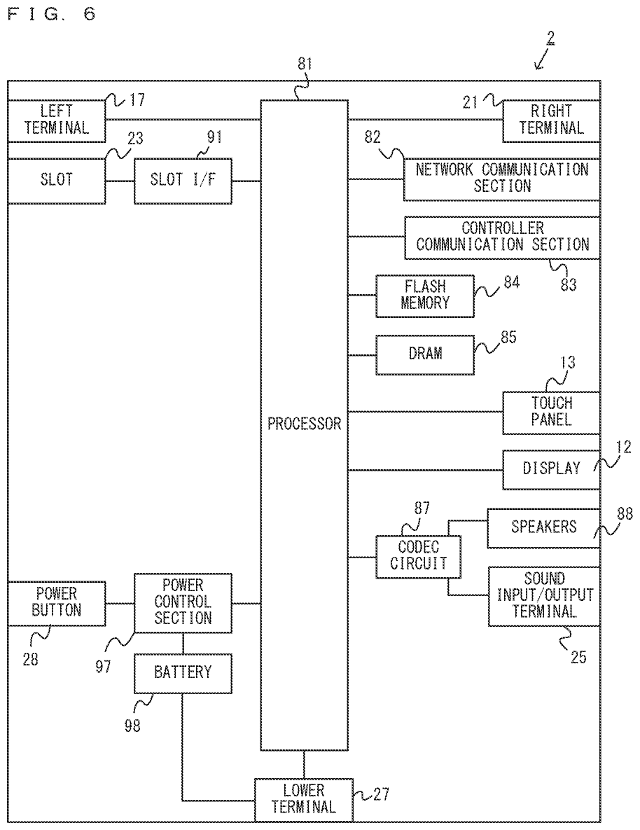

The main body apparatus 2 includes a speaker (i.e., a speaker 88 illustrated in FIG. 6) inside the housing 11. As illustrated in FIG. 3, speaker holes 11a and 11b are formed in the main surface of the housing 11. The speaker 88 outputs sounds through the speaker holes 11a and 11b.

The main body apparatus 2 also includes a left-side terminal 17 that enables wired communication between the main body apparatus 2 and the left controller 3, and a right-side terminal 21 that enables wired communication between the main body apparatus 2 and the right controller 4.

As illustrated in FIG. 3, the main body apparatus 2 includes a slot 23. The slot 23 is provided on an upper side surface of the housing 11. The slot 23 is so shaped as to allow a predetermined type of storage medium to be attached to the slot 23. The predetermined type of storage medium is, for example, a dedicated storage medium (e.g., a dedicated memory card) for the game system 1 and an information processing apparatus of the same type as the game system 1. The predetermined type of storage medium is used to store, for example, data (e.g., saved data of an application or the like) used by the main body apparatus 2 and/or a program (e.g., a program for an application or the like) executed by the main body apparatus 2. Further, the main body apparatus 2 includes a power button 28.

The main body apparatus 2 includes a lower-side terminal 27. The lower-side terminal 27 allows the main body apparatus 2 to communicate with a cradle. In the present example, the lower-side terminal 27 is a USB connector (more specifically, a female connector). When the unified apparatus or the main body apparatus 2 alone is placed on the cradle, the game system 1 can display, on a stationary monitor, an image that is generated and output by the main body apparatus 2. Also, in the present example, the cradle has the function of charging the unified apparatus or the main body apparatus 2 alone, being placed thereon. The cradle also functions as a hub device (specifically, a USB hub).

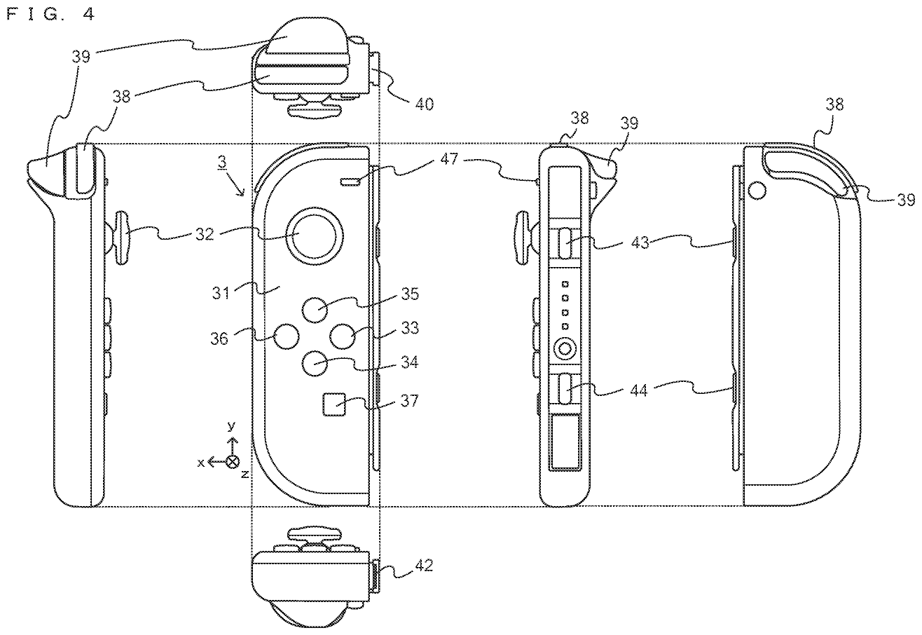

FIG. 4 illustrates six orthogonal views of an example of the left controller 3. As illustrated in FIG. 4, the left controller 3 includes a housing 31. In the present example, the housing 31 has a vertically long shape, e.g., is shaped to be long in an up-down direction (i.e., a y-axis direction illustrated in FIGS. 1 and 4). In the state in which the left controller 3 is detached from the main body apparatus 2, the left controller 3 can also be held in the orientation in which the left controller 3 is vertically long. The housing 31 has such a shape and a size that when held in the orientation in which the housing 31 is vertically long, the housing 31 can be held with one hand, particularly the left hand. Further, the left controller 3 can also be held in the orientation in which the left controller 3 is horizontally long. When held in the orientation in which the left controller 3 is horizontally long, the left controller 3 may be held with both hands.

The left controller 3 includes an analog stick 32. As illustrated in FIG. 4, the analog stick 32 is provided on a main surface of the housing 31. The analog stick 32 can be used as a direction input section with which a direction can be input. The user tilts the analog stick 32 and thereby can input a direction corresponding to the direction of the tilt (and input a magnitude corresponding to the angle of the tilt). It should be noted that the left controller 3 may include a directional pad, a slide stick that allows a slide input, or the like as the direction input section, instead of the analog stick. Further, in the present example, it is possible to provide an input by pressing the analog stick 32.

The left controller 3 includes various operation buttons. The left controller 3 includes four operation buttons 33 to 36 (specifically, a right direction button 33, a down direction button 34, an up direction button 35, and a left direction button 36) on the main surface of the housing 31. Further, the left controller 3 includes a record button 37 and a “−” (minus) button 47. The left controller 3 includes a first L-button 38 and a ZL-button 39 in an upper left portion of a side surface of the housing 31. Further, the left controller 3 includes a second L-button 43 and a second R-button 44, on the side surface of the housing 31 on which the left controller 3 is attached to the main body apparatus 2. These operation buttons are used to give commands depending on various programs (e.g., an OS program and an application program) executed by the main body apparatus 2.

The left controller 3 also includes a terminal 42 that enables wired communication between the left controller 3 and the main body apparatus 2.

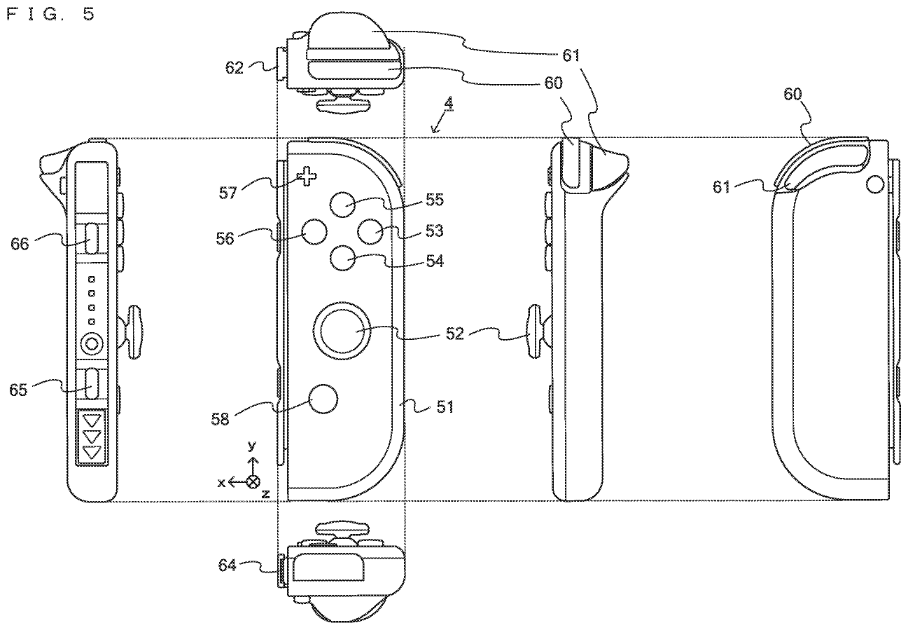

FIG. 5 illustrates six orthogonal views of an example of the right controller 4. As illustrated in FIG. 5, the right controller 4 includes a housing 51. In the present example, the housing 51 has a vertically long shape, e.g., is shaped to be long in the up-down direction. In the state in which the right controller 4 is detached from the main body apparatus 2, the right controller 4 can also be held in the orientation in which the right controller 4 is vertically long. The housing 51 has such a shape and a size that when held in the orientation in which the housing 51 is vertically long, the housing 51 can be held with one hand, particularly the right hand. Further, the right controller 4 can also be held in the orientation in which the right controller 4 is horizontally long. When held in the orientation in which the right controller 4 is horizontally long, the right controller 4 may be held with both hands.

Similarly to the left controller 3, the right controller 4 includes an analog stick 52 as a direction input section. In the present example, the analog stick 52 has the same configuration as that of the analog stick 32 of the left controller 3. Further, the right controller 4 may include a directional pad, a slide stick that allows a slide input, or the like, instead of the analog stick. Further, similarly to the left controller 3, the right controller 4 includes four operation buttons 53 to 56 (specifically, an A-button 53, a B-button 54, an X-button 55, and a Y-button 56) on a main surface of the housing 51. Further, the right controller 4 includes a “+” (plus) button 57 and a home button 58. Further, the right controller 4 includes a first R-button 60 and a ZR-button 61 in an upper right portion of a side surface of the housing 51. Further, similarly to the left controller 3, the right controller 4 includes a second L-button 65 and a second R-button 66.

Further, the right controller 4 includes a terminal 64 for allowing the right controller 4 to perform wired communication with the main body apparatus 2.

FIG. 6 is a block diagram illustrating an example of an internal configuration of the main body apparatus 2. The main body apparatus 2 includes components 81 to 91, 97, and 98 illustrated in FIG. 6 in addition to the components illustrated in FIG. 3. Some of the components 81 to 91, 97, and 98 may be implemented as electronic parts on an electronic circuit board, which is contained in the housing 11.

The main body apparatus 2 includes a processor 81. The processor 81 is an information processor for executing various types of information processing to be executed by the main body apparatus 2. For example, the CPU 81 may include only a central processing unit (CPU), or may be a system-on-a-chip (SoC) having a plurality of functions such as a CPU function and a graphics processing unit (GPU) function. The processor 81 executes an information processing program (e.g., a game program) stored in a storage section (specifically, an internal storage medium such as a flash memory 84, an external storage medium that is attached to the slot 23, or the like), thereby executing the various types of information processing.

The main body apparatus 2 includes a flash memory 84 and a dynamic random access memory (DRAM) 85 as examples of internal storage media built in itself. The flash memory 84 and the DRAM 85 are connected to the CPU 81. The flash memory 84 is mainly used to store various data (or programs) to be saved in the main body apparatus 2. The DRAM 85 is used to temporarily store various data used in information processing.

The main body apparatus 2 includes a slot interface (hereinafter abbreviated to “I/F”) 91. The slot I/F 91 is connected to the processor 81. The slot I/F 91 is connected to the slot 23, and reads and writes data from and to a predetermined type of storage medium (e.g., a dedicated memory card) attached to the slot 23, in accordance with commands from the processor 81.

The processor 81 reads and writes, as appropriate, data from and to the flash memory 84, the DRAM 85, and each of the above storage media, thereby executing the above information processing.

The main body apparatus 2 includes a network communication section 82. The network communication section 82 is connected to the processor 81. The network communication section 82 communicates (specifically, through wireless communication) with an external apparatus via a network. In the present example, as a first communication form, the network communication section 82 connects to a wireless LAN and communicates with an external apparatus, using a method compliant with the Wi-Fi standard. Further, as a second communication form, the network communication section 82 wirelessly communicates with another main body apparatus 2 of the same type, using a predetermined communication method (e.g., communication based on a particular protocol or infrared light communication). It should be noted that the wireless communication in the above second communication form achieves the function of allowing so-called “local communication”, in which the main body apparatus 2 can wirelessly communicate with another main body apparatus 2 located in a closed local network area, and the plurality of main body apparatuses 2 directly communicate with each other to exchange data.

The main body apparatus 2 includes a controller communication section 83. The controller communication section 83 is connected to the processor 81. The controller communication section 83 wirelessly communicates with the left controller 3 and/or the right controller 4. The main body apparatus 2 may communicate with the left and right controllers 3 and 4 using any suitable communication method. In the present example, the controller communication section 83 performs communication with the left and right controllers 3 and 4 in accordance with the Bluetooth (registered trademark) standard.

The processor 81 is connected to the left-side terminal 17, the right-side terminal 21, and the lower-side terminal 27. When performing wired communication with the left controller 3, the processor 81 transmits data to the left controller 3 via the left-side terminal 17 and also receives operation data from the left controller 3 via the left-side terminal 17. Further, when performing wired communication with the right controller 4, the processor 81 transmits data to the right controller 4 via the right-side terminal 21 and also receives operation data from the right controller 4 via the right-side terminal 21. Further, when communicating with the cradle, the processor 81 transmits data to the cradle via the lower-side terminal 27. As described above, in the present example, the main body apparatus 2 can perform both wired communication and wireless communication with each of the left and right controllers 3 and 4. Further, when the unified apparatus obtained by attaching the left and right controllers 3 and 4 to the main body apparatus 2 or the main body apparatus 2 alone is attached to the cradle, the main body apparatus 2 can output data (e.g., image data or sound data) to a stationary monitor or the like via the cradle.

Here, the main body apparatus 2 can communicate with a plurality of left controllers 3 simultaneously (or in parallel). Further, the main body apparatus 2 can communicate with a plurality of right controllers 4 simultaneously (or in parallel). Thus, a plurality of users can simultaneously provide inputs to the main body apparatus 2, each using a set of left and right controllers 3 and 4. As an example, a first user can provide an input to the main body apparatus 2 using a first set of left and right controllers 3 and 4, and at the same time, a second user can provide an input to the main body apparatus 2 using a second set of left and right controllers 3 and 4.

Further, the display 12 is connected to the processor 81. The processor 81 displays, on the display 12, a generated image (e.g., an image generated by executing the above information processing) and/or an externally obtained image.

The main body apparatus 2 includes a codec circuit 87 and speakers (specifically, a left speaker and a right speaker) 88. The codec circuit 87 is connected to the speakers 88 and an audio input/output terminal 25 and also connected to the processor 81. The codec circuit 87 is for controlling the input and output of audio data to and from the speakers 88 and the sound input/output terminal 25.

The main body apparatus 2 includes a power control section 97 and a battery 98. The power control section 97 is connected to the battery 98 and the processor 81. Further, although not illustrated, the power control section 97 is connected to components of the main body apparatus 2 (specifically, components that receive power supplied from the battery 98, the left-side terminal 17, and the right-side terminal 21). Based on a command from the processor 81, the power control section 97 controls the supply of power from the battery 98 to each of the above components.

Further, the battery 98 is connected to the lower-side terminal 27. When an external charging device (e.g., the cradle) is connected to the lower-side terminal 27, and power is supplied to the main body apparatus 2 via the lower-side terminal 27, the battery 98 is charged with the supplied power.

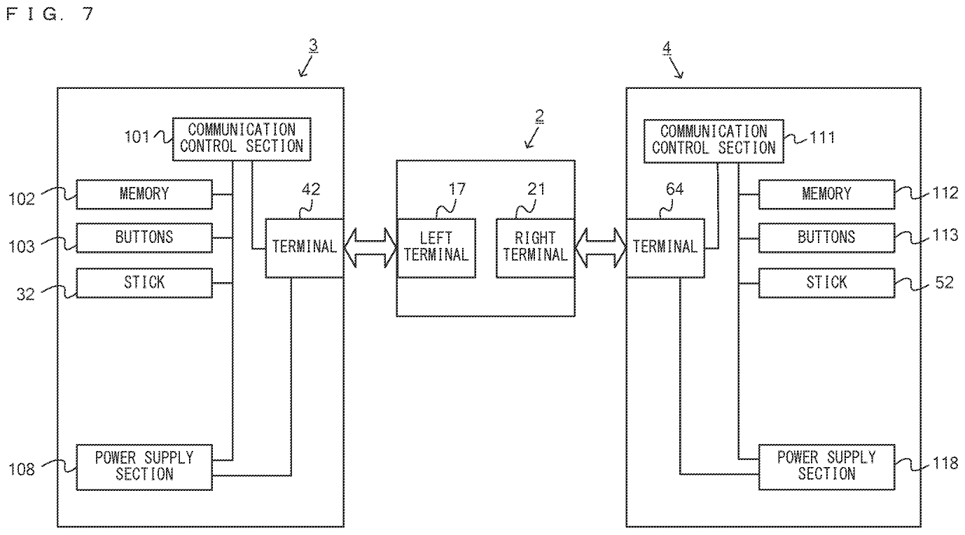

FIG. 7 is a block diagram illustrating examples of the internal configurations of the main body apparatus 2, the left controller 3, and the right controller 4. It should be noted that the details of the internal configuration of the main body apparatus 2 are illustrated in FIG. 6 and therefore are omitted in FIG. 7.

The left controller 3 includes a communication control section 101, which communicates with the main body apparatus 2. As illustrated in FIG. 7, the communication control section 101 is connected to components including the terminal 42. In the present example, the communication control section 101 can communicate with the main body apparatus 2 through both wired communication via the terminal 42 and wireless communication without via the terminal 42. The communication control section 101 controls the method for communication performed by the left controller 3 with the main body apparatus 2. That is, when the left controller 3 is attached to the main body apparatus 2, the communication control section 101 communicates with the main body apparatus 2 via the terminal 42. Further, when the left controller 3 is detached from the main body apparatus 2, the communication control section 101 wirelessly communicates with the main body apparatus 2 (specifically, the controller communication section 83). The wireless communication between the communication control section 101 and the controller communication section 83 is performed in accordance with the Bluetooth (registered trademark) standard, for example.

Further, the left controller 3 includes a memory 102 such as a flash memory. The communication control section 101 includes, for example, a microcomputer (or a microprocessor) and executes firmware stored in the memory 102, thereby performing various processes.

The left controller 3 includes buttons 103 (specifically, the buttons 33 to 39, 43, 44, and 47). Further, the left controller 3 includes the analog stick (“stick” in FIG. 7) 32. Each of the buttons 103 and the analog stick 32 outputs information regarding an operation performed on itself to the communication control section 101 repeatedly at appropriate timing.

The communication control section 101 obtains information regarding an input (specifically, information regarding an operation or the detection result of the sensor) from each of input sections (specifically, the buttons 103 and the analog stick 32). The communication control section 101 transmits operation data including the obtained information (or information obtained by performing predetermined processing on the obtained information) to the main body apparatus 2. It should be noted that the operation data is transmitted repeatedly, once every predetermined time. It should be noted that the interval at which the information regarding an input is transmitted from each of the input sections to the main body apparatus 2 may or may not be the same.

The above operation data is transmitted to the main body apparatus 2, whereby the main body apparatus 2 can obtain inputs provided to the left controller 3. That is, the main body apparatus 2 can determine operations on the buttons 103 and the analog stick 32 based on the operation data.

The left controller 3 includes a power supply section 108. In the present example, the power supply section 108 includes a battery and a power control circuit. Although not illustrated in FIG. 7, the power control circuit is connected to the battery and also connected to components of the left controller 3 (specifically, components that receive power supplied from the battery).

As illustrated in FIG. 7, the right controller 4 includes a communication control section 111, which communicates with the main body apparatus 2. Further, the right controller 4 includes a memory 112, which is connected to the communication control section 111. The communication control section 111 is connected to components including the terminal 64. The communication control section 111 and the memory 112 have functions similar to those of the communication control section 101 and the memory 102, respectively, of the left controller 3. Thus, a communication control section 111 can communicate with the main body apparatus 2 through both wired communication via the terminal 64 and wireless communication without via the terminal 64 (specifically, communication compliant with the Bluetooth (registered trademark) standard). The communication control section 111 controls the method for communication performed by the right controller 4 with the main body apparatus 2.

The right controller 4 includes input sections similar to the input sections of the left controller 3. Specifically, the right controller 4 includes buttons 113, and the analog stick 52. These input sections have functions similar to those of the input sections of the left controller 3 and operate similarly to the input sections of the left controller 3.

The right controller 4 includes a power supply section 118. The power supply section 118 has a function similar to that of the power supply section 108 of the left controller 3 and operates similarly to the power supply section 108.

As described above, in the game system 1 of the present example, the left controller 3 and the right controller 4 are removable from the main body apparatus 2. In addition, when the unified apparatus obtained by attaching the left controller 3 and the right controller 4 to the main body apparatus 2 or the main body apparatus 2 alone is attached to the cradle, an image (and sound) can be output on an external display device, such as a stationary monitor or the like. The game system 1 will be described below according to an embodiment in which an image is displayed on the display 12. It should be noted that in the case in which the game system 1 is used in an embodiment in which an image is displayed on the display 12, the game system 1 may be used with the left controller 3 and the right controller 4 attached to the main body apparatus 2 (e.g., the main body apparatus 2, the left controller 3, and the right controller 4 are integrated in a single housing).

A game is played using a virtual space displayed on the display 12, according to operations performed on the operation buttons and sticks of the left controller 3 and/or the right controller 4, or touch operations performed on the touch panel 13 of the main body apparatus 2, in the game system 1. In the present example, as an example, a game can be played using a player object PO that performs action in a virtual space according to the user's operation input performed using the operation buttons, the sticks, and the touch panel 13.

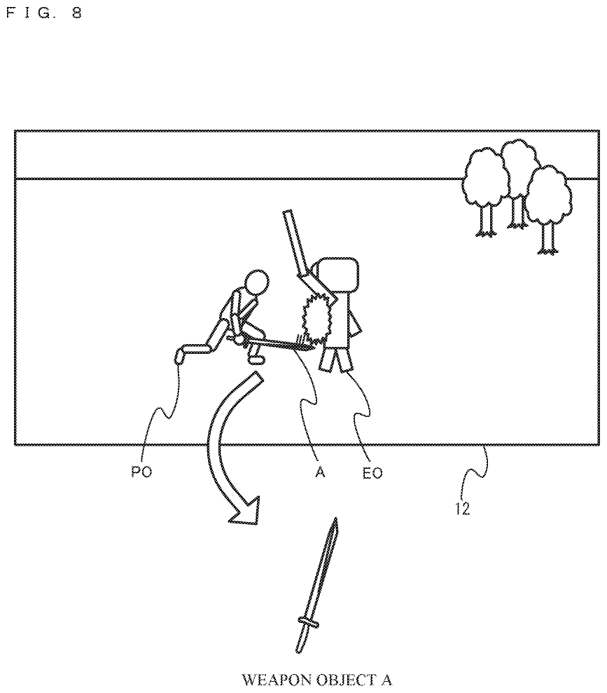

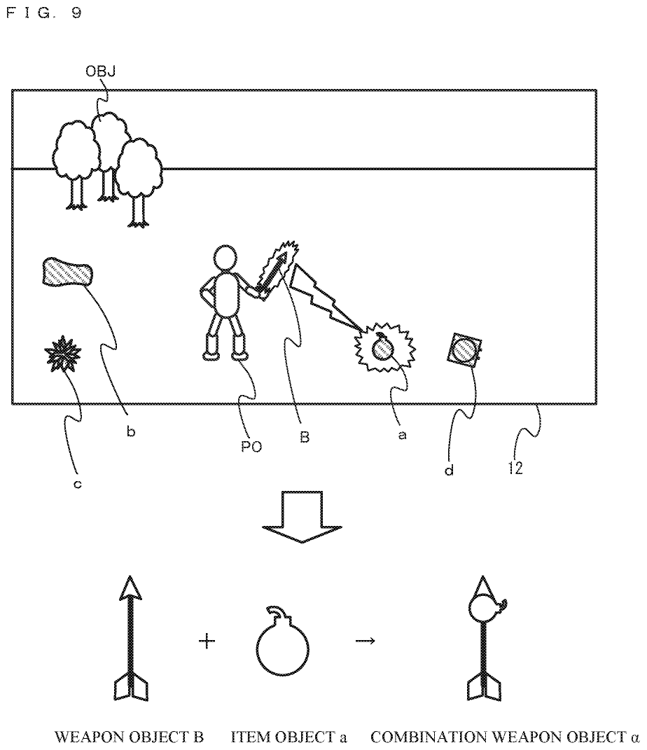

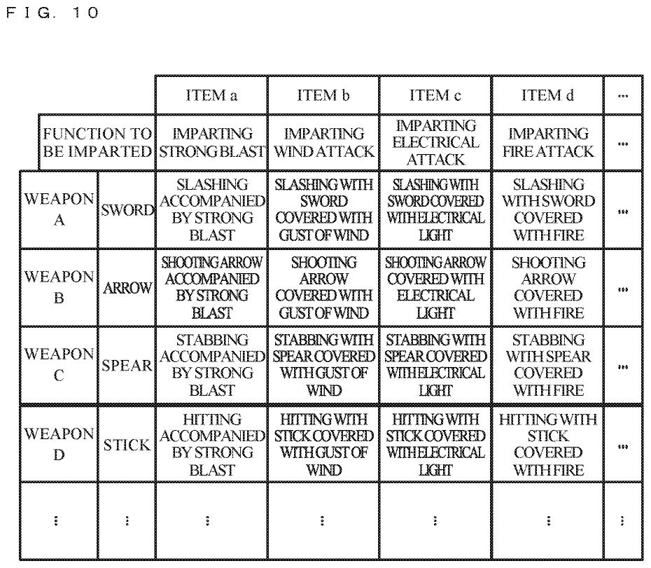

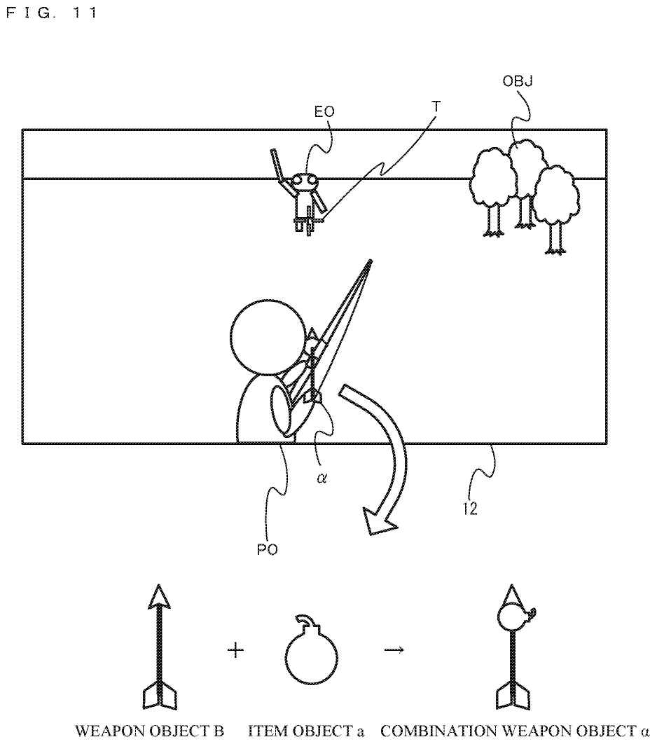

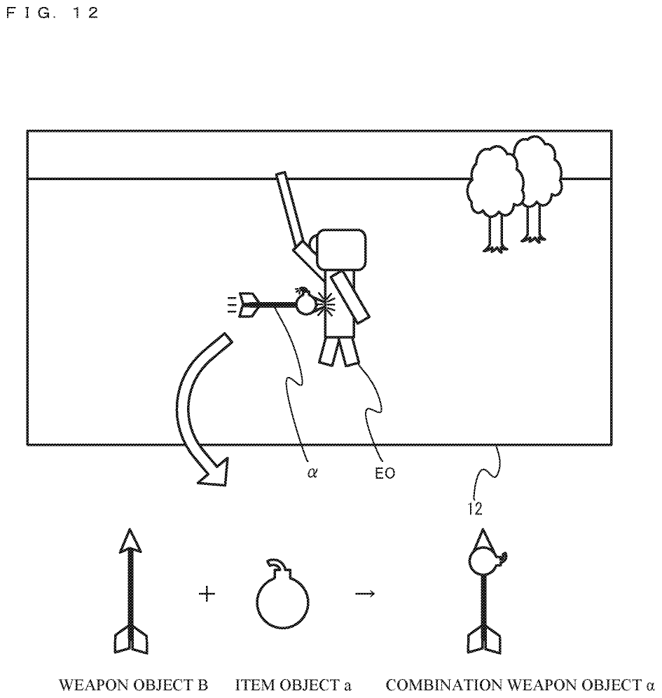

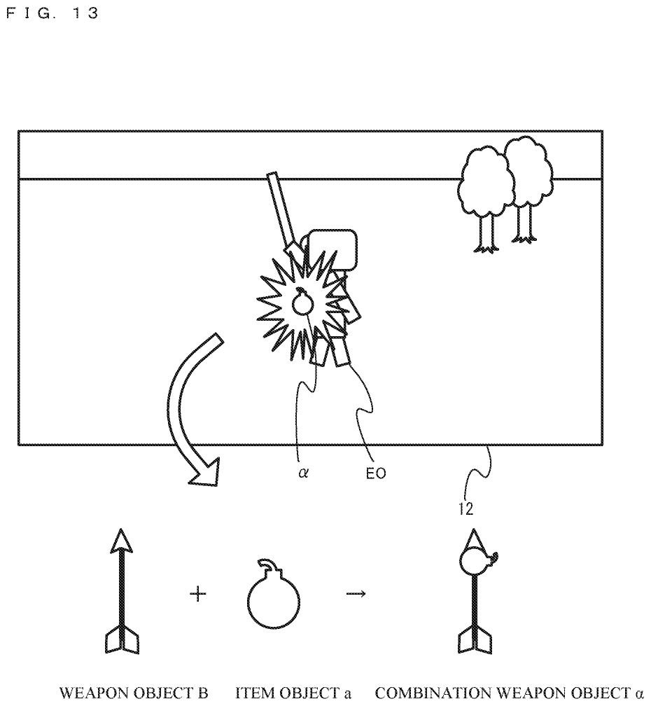

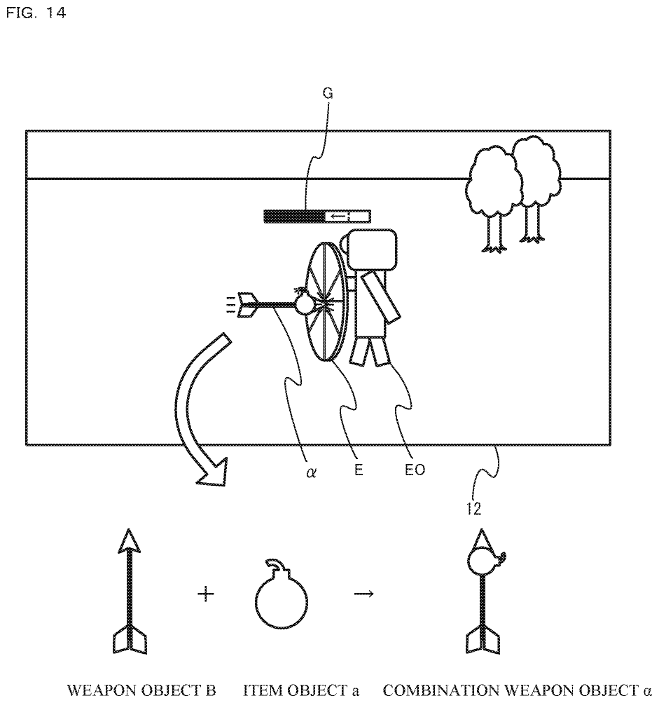

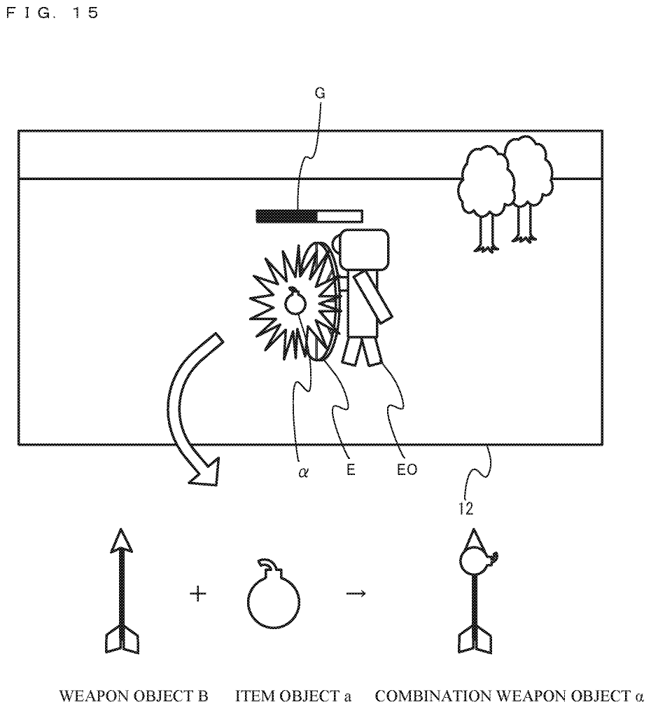

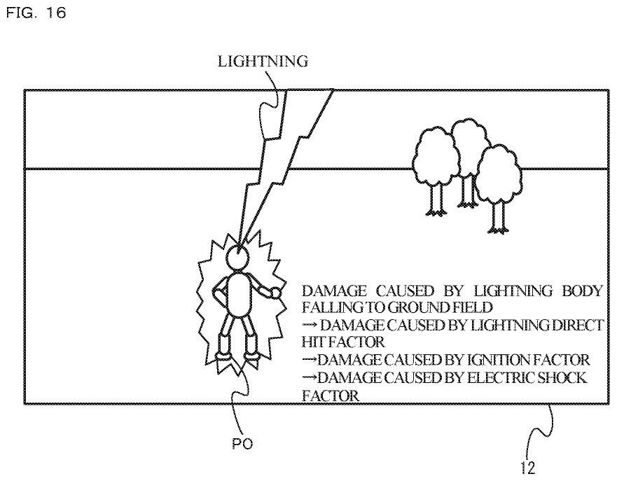

A game process that is executed in the game system 1 will be outlined with reference to FIGS. 8 to 14. It should be noted that FIG. 8 is a diagram illustrating an example of a game image showing a scene in which a player object PO attacks an opponent object EO using a weapon object A in a virtual space. FIG. 9 is a diagram illustrating an example of a game image showing a scene in which a player object PO synthesizes a combination weapon object α in a virtual space. FIG. 10 is a diagram illustrating an example of a relationship between a weapon object, an item object, a combination weapon object generated based on these objects, and the effect of an attack using the combination weapon object. FIG. 11 is a diagram illustrating an example of a game image of a first stage in which a player object PO attacks an opponent object EO using a combination weapon object α in a virtual space. FIG. 12 is a diagram illustrating an example of a game image of a second stage in which a player object PO attacks an opponent object EO using a combination weapon object α in a virtual space. FIG. 13 is a diagram illustrating an example of a game image of a third stage in which a player object PO attacks an opponent object EO using a combination weapon object α in a virtual space. FIG. 14 is a diagram illustrating an example of a game image of a first stage in which an opponent object EO defends itself, using a defensive object E, against an attack from a player object PO using a combination weapon object a in a virtual space. FIG. 15 is a diagram illustrating an example of a game image of a second stage in which an opponent object EO defends itself, using a defensive object E, against an attack from a player object PO using a combination weapon object α in a virtual space. FIG. 16 is a diagram illustrating an example of a game image showing a scene in which a player object PO is under a lightning attack in a virtual space.

FIG. 8 illustrates a game image in which a player object PO and an opponent object EO are disposed in a virtual space. The player object PO is a player character whose action is controlled based on the user's operation input. The opponent object EO is a character whose action is automatically controlled by the processor 81. A plurality of opponent objects EO may be disposed in the virtual space. Although in the present example, a game image is displayed on the display 12 of the main body apparatus 2, a game image may be displayed on other display devices connected to the main body apparatus 2.

The player object PO can perform the action of attacking other characters and virtual objects (e.g., opponent objects EO) according to the user's operation input. As an example, control can be performed such that the player object PO performs an attack action using a weapon according to the user's operation input. In the present example, as a weapon that is used by the player object PO in an attack action, a weapon object, a combination weapon object, and the like are prepared. The player object PO can be equipped with any of a weapon object and a combination weapon object, and can perform an attack action using a weapon object or a combination weapon object according to the user's operation input.

In the present example, a life value (the value of remaining physical strength that allows activity in the virtual space) is set for each of the player object PO, other characters (e.g., an opponent object EO), and virtual objects that appear in the virtual space. When an attack action from another object causes damage, the life value is reduced by a predetermined amount based on a calculated damage amount. For example, when the player object PO fails to defend itself against an attack from another object or the like, the life value of the player object PO is reduced by a predetermined amount based on a damage amount calculated based on the successful attack. When the life value is zero, the player object PO may be defeated by the attacking object or the like, so that the game may be over. Meanwhile, when another type of object (e.g., an opponent object EO) fails to defend itself against an attack from another object (e.g., the player object PO) or the like, the life value of the attacked object may be reduced by a predetermined amount based on a damage amount calculated based on the successful attack. When the life value is zero, the attacked object may be removed from the virtual space.

In FIG. 8, the player object PO has a weapon object A that is an example of a weapon with which the player object PO can be equipped, and is performing the action of attacking an opponent object EO using the weapon object A. For example, when the player object PO is holding the weapon object A, then if the user gives an action command, the player object PO performs the action of swinging the held weapon object A (thereby attacking an opponent object EO). When an opponent character EO is disposed in a range in which the player object PO's attack action has an attack effect, then if the weapon object A hits the opponent character EO, the attack causes damage to the opponent character EO.

In FIG. 8, the weapon object A is a sword object. Therefore, when the user causes the player object PO to perform an attack action, the player object PO exhibits a basic attack function by performing an attack action of swinging the sword object so as to “slash another object that is brought into contact therewith”. For example, when the swung weapon object A is brought into contact with an opponent object EO, the opponent object EO is slashed, which causes predetermined damage to the opponent object EO.

In the present example, when the player object PO's attack action using a weapon object causes damage to an opponent object EO, an attack occurs each time the attack action is performed once, and it is determined whether or not the attack is successful. As an example, when the player object PO performs an attack action using a weapon object against an opponent object EO, then if the weapon object hits the opponent object EO, a process of determining whether or not the attack is successful is executed, and a process of calculating a damage amount to the opponent object EO is executed if the attack is successful. Thereafter, during a predetermined period of time (e.g., the period of time that corresponds to 30 frames, each frame being the cycle of a process (described below) executed in the game system 1) after the process, a process of causing new damage to the processed opponent object EO is not executed, which period of time is referred to as an “invincibility period”. As a result, even when the state that a weapon object is sticking to an opponent object EO is continued, damage to the opponent object EO is not continued. Therefore, the damage calculation is performed once each time an attack action is performed once.

It should be noted that the player object PO may be able to be equipped with a plurality of types of weapon objects. Here, in the present example, the player object PO may be able to be equipped with a short-range attack weapon object such as a sword object, a spear object, a stick object, or the like, a long-range attack weapon object such as a bow-and-arrow object, and a defensive weapon object such as a shield object for defending itself against an attack, and the like, together. In that case, the player object PO can perform an attack action while holding one of the weapon objects and the defensive objects with which the player object PO is equipped. Specifically, the player object PO is caused to adopt a position in which the player object PO holds a chosen weapon or defensive object according to the user's action command to choose and hold a weapon or defensive object, and is caused to perform an attack or defensive action using the weapon or defensive object according to the user's action command. It should be noted that in another example, the player object PO can be equipped with only one weapon object and only one defensive object together. Although in the present example an attack action is performed by the player object PO equipped with a weapon object, the player object PO may perform the action of punching, kicking, gripping, or the like as an attack action.

Next, an example of a method of generating a combination weapon object, which is another example of a weapon with which the player object PO can be equipped, will be described with reference to FIG. 9. As illustrated in FIG. 9, a plurality of item objects are disposed on a game field in the virtual space. In the case in which an item object(s) can be combined with a weapon object carried by the player object PO to generate a combination weapon object, the item objects that can be combined are displayed in a display form that is different from that of objects other than said item objects. Specifically, the item objects disposed in the virtual space may be displayed in a color that is different from that of other objects, may be displayed with an effect image added thereto, or may be displayed with an effect image added thereto that is different from that added to other objects. In the example of FIG. 9, item objects a to d are displayed in a display form that is different from that of a tree object OBJ, which is not an item object (it should be noted that in FIG. 9, a difference in display form is indicated by hatching). As a result, when a game image showing a game field is displayed, the item objects that can be combined, of the objects on the game field, can be presented in an easy-to-understand manner. It should be noted that the item objects displayed in a display form different from that of other objects may be some of the item objects disposed on a game field that are located in a determination range described below.

In addition, in a state in which a combination weapon object can be generated, one(s) of the item objects is designated as an item object to be subjected to a combination process (referred to as an “item object of interest”). For example, as illustrated in FIG. 9, an effect image is added to an item object of interest. In the example of FIG. 9, the item object a is an item object of interest, and an effect image is added to the item object a.

In the present example, an item object of interest is one that is located closest to the player character PO, of item objects that are present in a determination range with reference to the location of the player character PO. It should be noted that in another example, an item object of interest may be one that is determined based on the location and orientation of the player character PO, of item objects that are present in a determination range with reference to the location of the player character PO. As an example, the determination range spreads out in front of the player character PO (specifically, an angular range having a predetermined maximum angle on either side with reference to a front direction) and extends up to a predetermined distance from the location of the player character PO. It should be noted that the determination range may be any range that is determined based on the location of the player character PO. In another example, the determination range may be within a predetermined distance from the location of the player character PO (independently of the orientation of the player object), or may be the range of a game field displayed on the display 12.

Thus, by adding an effect image to an item object of interest to be subjected to the combination process, the item object of interest to be subjected to the combination process can be presented in an easy-to-understand manner for the user when a game image showing a game field is displayed. It should be noted that the effect image may be any image that allows the user to distinguish the item object of interest to be subjected to the combination process from other item objects.

As illustrated in FIG. 9, an effect image indicating an item object to be subjected to the combination process has a shape suggesting that the item object a, which is an item object of interest, is linked to a weapon object B carried by the player character PO. Thus, the effect image can present the item object of interest in association with a weapon object that is to be subjected to the combination process. Thereafter, a combination weapon object is generated based on the weapon object and the item object that are associated with each other by the effect image. Therefore, the effect image can present a weapon object and an item object that are elements that can constitute a combination weapon object to the user in an easy-to-understand manner.

In a state in which the effect image of FIG. 9 is displayed, when a combination command is given from the user, the item object of interest is caused to disappear from the game field, and a combination weapon object is generated. For example, FIG. 9 illustrates an example of a situation in which a combination weapon object α is generated by combining the weapon object B with the item object a. When the combination weapon object α is generated, a scene is displayed in which the item object a approaches the weapon object B, and thereafter, the weapon object B is changed into the combination weapon object α.

It should be noted that in the present example, objects (including item objects) that appear in a game may include objects that can be stored by the player object PO, and objects that cannot be stored by the player object PO. A state in which the player object PO stores an object refers to a state in which the player object PO is allowed to carry the object without being equipped with or holding the object, or the like. No stored objects are displayed on a game field. When the player object PO retrieves a stored object, the player object PO can dispose the object on a game field or use the object (including being equipped with the object, holding the object, and combining the object). For example, when the player object PO is in a predetermined state (holding the weapon object B in order to perform an attack action), then if an item use command is given to combine an item object designated from those stored by the player object PO with a weapon object with which the player object PO is equipped (e.g., a command to integrate an arrow object included in the weapon object B with which the player object PO is equipped, with the stored item object a), a combination weapon object (e.g., the combination weapon object α) can be generated using a stored item object.

The combination weapon object α has an appearance showing a combination of the weapon object B and the item object a with the item object a attached to a tip portion of the weapon object B (in other words, the weapon object B and the item object a are integrated together with the item object a replacing a tip portion of the weapon object B). Thus, in the present example, a combination weapon object (e.g., the combination weapon object α) has an appearance including at least a portion of the appearance of a weapon object (e.g., the weapon object A) that is a constituent element of the combination weapon object and at least a portion of the appearance of an item object (e.g., the item object a) that is another constituent element of the combination weapon object. Therefore, the combination weapon object can give the user the impression that the combination weapon object is a combination of the weapon object and the item object.

It should be noted that a portion of a weapon object at which an item object is combined with the weapon object may be set, depending on a combination of the item object and the weapon object. For example, as illustrated in FIG. 9, in the case in which an item object that is a bomb object is combined with a bow-and-arrow object, which is a long-range weapon object, the resultant combination weapon object may have an appearance in which the item object (bomb object) is combined with the bow-and-arrow object at an arrowhead portion, nock portion, or shaft portion of an arrow object included in the bow-and-arrow object. Alternatively, in the case in which an item object is combined with a shield object, which is a defensive object, the resultant combination weapon object may have an appearance in which the item object is combined with the shield object at a center portion or outer frame portion of the shield object.

In addition, in the example of FIG. 9, the combination weapon object has an appearance in which a portion of the appearance of the weapon object B, which is a constituent element of the combination weapon object, is replaced with all of the appearance of the item object a, which is another constituent element of the combination weapon object. It should be noted that a combination weapon object may have an appearance in which a portion of the appearance of a weapon object that is a constituent element of the combination weapon object is replaced with a portion of the appearance of the item object that is another constituent element of the combination weapon object. Alternatively, a combination weapon object may have an appearance in which all of the appearance of a weapon object that is a constituent element of the combination weapon object is combined with all or a portion of the appearance of an item object that is another constituent element of the combination weapon object.

In addition, an item object may be previously disposed on a game field at the beginning of a game, or may be disposed by being dropped by an opponent object EO, or in response to the defeat of an opponent object EO, or may be obtained from an object other than item objects (e.g., a firewood object that is disposed on a game field by the player character PO attacking a tree object OBJ). In addition, objects that do not serve as an item object may be disposed on a game field. In addition, a weapon object may serve as an item object. In that case, weapon objects may be combined together to generate a combination weapon object.

In addition, as an object with which an item object is to be combined, a combination weapon object that already includes another item object may be able to be designated. In that case, the item object already included in the designated combination weapon object may be removed or deleted so that the function of the item object is removed, and the resultant weapon object may be newly combined with a newly designated item object. As an example, when an item use command to combine a combination weapon object with a newly designated item object is given, a process of removing or deleting the item object already combined and a process of combining the newly designated item object may be performed in combination. As another example, after the user gives a command to remove the item object already combined, so that the process of removing or deleting the item object is executed earlier, an item use command may be newly given to attach a newly designated item object to a weapon object from which the previous item object has been removed.

Next, the performance of attacking using a combination weapon object will be described with reference to FIG. 10. In an example illustrated in FIG. 10, of objects appearing in a game, example weapon objects that can be used for synthesis of a combination weapon object are indicated by A to D, and example item objects that can be used for synthesis of a combination weapon object are indicated by a to d. In the present example, as illustrated in FIG. 10, for all combinations of the weapon objects A to D with the item objects a to d, combination weapon objects are set as a result of the combination process. Thus, each of the weapon objects A to D, which can be used in the combination process, can be combined with all of the item objects a to d, which can be used in the combination process.

The performance of a combination weapon object is a combination of the function of an original weapon object and the performance of an item object that is combined with the weapon object. As an example, the combination weapon object that is generated by combining the item object c having the function of giving an electric attack with the weapon object A that is a sword object having the function of slashing an attack target, has the performance of slashing with the combination weapon object covered with electric light (or the performance of slashing while emitting electric light). As a result, an attack using the combination weapon object can cause damage to an attack target with the additional effect of giving the electric attack of the item object c combined being added to the attack effect of slashing of the original weapon object A. It should be noted that in some embodiment of an attack using the combination weapon object, one of the attack effect of slashing of the original weapon object A and the additional effect of giving an electric attack of the item object c combined may have an effect on an attack target.

As another example, as an example, a combination weapon object that is generated by combining the weapon object B that is an arrow object which has the function of shooting an attack target with the item object a that has the function of adding a strong blast, has the function of shooting an arrow object that is accompanied by a strong blast. As a result, an attack using the combination weapon object can cause damage to an attack target with the additional effect of adding a strong blast by the combined item object a added to the attack effect of shooting by the original weapon object B. It should be noted that in some forms of an attack using the combination weapon object, one of the attack effect of shooting by the original weapon object B and the additional effect of adding a strong blast by the combined item object a may have an effect on an attack target.

It should be noted that a performance that an item object adds to a combination weapon object may be varied depending on a weapon object that is a constituent element of the combination weapon object (e.g., a different effect (damage) on an attack target). Alternatively, a performance that an item object adds to a combination weapon object may be the same irrespective of a weapon object that is a constituent element of the combination weapon object.

In addition, a predetermined function that is possessed by an item object does not need to be exactly the same as a function that is added to a combination weapon object by the item object being combined. The two functions may be considered to be the same as long as the user can recognize that the two functions are associated with each other. For example, concerning the item object a and the combination weapon object α, the functions of the two objects can be considered to be the same if both of the two objects have the function of “generating a strong blast (explosion)” in a broad sense, and this is the case even if there is a difference in the size of a strong blast (explosion), the strength of a strong blast (explosion), the form of a strong blast (explosion), the length of time of continuation of a strong blast (explosion), or the like therebetween.

Thus, the function that is exhibited by an item object included in a combination weapon object is not one that is exhibited on the assumption that the basic attack function of the original weapon object is exhibited (e.g., the function of shooting another object that is hit), and is one that is exhibited independently of exhibition of the basic attack function (i.e., without the assumption that the basic attack function is exhibited) (e.g., in the present example, blowing a strong blast). It should be noted that in the present example, the function that is exhibited by the item object a included in the combination weapon object α may be exhibited when an attack action is performed using the combination weapon object α, and may not be exhibited when an attack action is not performed using the combination weapon object α.

As described above, a combination weapon object has a function different from that of a weapon object that is a constituent element of the combination weapon object. Here, the meaning of the term “a combination weapon object has a function different from that of a weapon object” includes: (a) an ability value set for the combination weapon object is different from an ability value set for the weapon object; and (b) the combination weapon object has a function that is not possessed by the weapon object (or the weapon object has a function that is not possessed by the combination weapon object). For example, examples of the function include the function of giving thrust to a combination weapon object by combining an item object that obtains thrust, the function of extending the attack range of a combination weapon object by combining an item object that extends, and the function of projecting a gust of wind, fire, or a strong blast by combining an item object that projects a gust of wind, fire, or a strong blast. As an example, the combination weapon object α of FIG. 9 is generated by combining an arrow object that is a weapon object capable of performing a shooting attack, with a bomb object that is an item object which imparts a strong blast, and therefore, has the function of blowing a strong blast during an attack.

An example of the action of attacking an opponent object EO using a combination weapon object will be described with reference to FIGS. 11 to 13. A player object PO illustrated in FIG. 11 carries a combination weapon object α that is an example of a weapon with which the player object PO can be equipped. As described above, the combination weapon object α is generated by combining the weapon object B (a bow-and-arrow object; more specifically, an arrow object) with the item object a. When the user causes the player object PO to perform an attack action, the combination weapon object α exhibits a basic attack function that is performed by the attack action of projecting an arrow object, i.e., “shooting an arrow object at another object”. For example, when the arrow object projected using the combination weapon object α sticks into an opponent object EO, the sticking can cause predetermined damage to the opponent object EO.

In addition, the combination weapon object α includes the item object a (bomb object) that imparts a strong blast. Therefore, when the user causes the player object PO to perform an attack action, the shot object can be caused to exhibit the function of generating a strong blast due to the explosion of the combination weapon object α. Thereafter, when the strong blast (radiation actor) generated by the explosion of the combination weapon object α hits an opponent object EO, the strong blast can also cause predetermined damage to the opponent object EO.

In FIG. 11, the player object PO is holding the combination weapon object α after having performed the action of nocking an arrow object combined with a bomb object (shooting ready state). In addition, an aiming point marker T is displayed which indicates the direction in which the arrow object will be shot when the user gives a shoot command. In the shooting ready state, the user is allowed to give a command to change the shooting direction in addition to the shoot command. When the user gives a shoot command, the player object PO performs the attack action of projecting the arrow object combined with the item object a (combination weapon object α) based on the shooting direction indicated by the aiming point marker T.

For example, in an example illustrated in FIG. 12, a first stage is shown in which the arrow object (combination weapon object α) projected from the player object PO has hit an opponent object EO. When the arrow object of the combination weapon object α hits an opponent object EO due to the player object PO's attack action, damage is caused to the opponent object EO due to the attack of sticking the arrow object into the opponent object EO (referred to as a first attack).

In the present example, a plurality of attacks occur when the player object PO performs an attack action using a combination weapon object once. For example, when an attack action is performed using a combination weapon object obtained by combining a weapon object with an item object, at least two attacks occur, including an attack caused due to hit by the weapon object, an attack caused due to hit by the item object, an attack caused by the function of the item object, and the like. Here, the plurality of attacks are a series of attacks that occur during a single attack action, and are associated with each other with reference to the attack action.

For example, as illustrated in FIG. 12, when the player object PO performs an attack action using the combination weapon object α, so that the combination weapon object α (arrow object) sticks into an opponent object EO, the hitting of the opponent object EO by the arrow object (weapon object B) is followed by execution of a process of determining whether or not the first attack is successful and a process of calculating a damage amount to the opponent object EO if the first attack is successful.

After the first attack, the hitting of the opponent object EO by the item object a included in the combination weapon object α is followed by execution of a process of determining whether or not the second attack is successful and a process of calculating a damage amount to the opponent object EO if the second attack is successful.

In addition, as illustrated in FIG. 13, after the second attack, the hitting of the opponent object EO by a strong blast (radiation actor) generated by the explosion of the item object a included in the combination weapon object α is followed by execution of a process of determining whether or not the third attack is successful and a process of calculating a damage amount to the opponent object EO if the third attack is successful.

In the present example, the same attack ID is assigned to a series of attacks (the first to third attacks) triggered by such a single attack action. Even during the invincibility period caused by the first attack, the process of calculating a damage amount is executed for each of the attacks (second and third attacks) having the same attack ID as that of the first attack, so that the plurality of attacks can each cause damage to an opponent object EO.

For example, when the user gives a shoot command to start an attack action that triggers the series of attacks, a unique new attack ID is assigned to the first attack performed by the arrow object included in the combination weapon object α. Thereafter, when the first attack is performed in which the arrow object sticks into an opponent object EO, a process of determining whether or not the first attack is successful and a process of calculating a damage amount to the opponent object EO if the first attack is successful are executed. If the first attack is successful, the damage amount is given to the opponent object EO. It should be noted that the unique new attack ID is assigned to the first attack at the time when it is determined that the first attack has occurred, e.g., at the time when the user gives a shoot command, or at the time when the arrow object hits the opponent object EO.

In addition, the same attack ID that is assigned to the first attack in the series of attacks associated with each other is assigned to the second attack in which the item object a included in the combination weapon object α hits the opponent object EO. It should be noted that the attack ID is assigned to the second attack at the time when it is determined that the second attack has occurred, e.g., at the time when the user gives a command to shoot the item object a together with the arrow object, during a period of time that the item object a combined with the arrow object is flying in the virtual space, or at the time when the item object a hits the opponent object EO. The attack ID of the second attack in which the item object a hits the opponent object EO is the same as that of the past first attack in the series of attacks. Therefore, when the result of the first attack having the same attack ID indicates that the first attack is successful, the process of calculating a damage amount to the opponent object EO by the second attack is executed, assuming that the second attack is also successful, and the damage amount by the second attack is given to the opponent object EO.

In addition, the same attack ID that is assigned to the second attack in the series of attacks associated with each other is assigned to the third attack performed by the function (explosive phenomenon) of the item object a included in the combination weapon object α against the opponent object EO. As a result, the same attack ID is assigned to all of a series of attacks triggered by a single attack action. It should be noted that the attack ID is assigned to the third attack at the time when it is determined that the third attack has occurred, e.g., at the time when the item object a starts exploding, at the same time when the explosion starts, or at the time when the radiation actor of a strong blast generated by the explosion of the item object a hits the opponent object EO. The attack ID of the third attack against the opponent object EO by the function of the item object a is the same as that of the past second attack in the series of attacks (i.e., the same as that of the past first attack). Therefore, when the result of the second attack having the same attack ID indicates that the second attack is successful, the process of calculating a damage amount to the opponent object EO by the third attack is executed, assuming that the third attack is also successful, and the damage amount by the third attack is given to the opponent object EO. It should be noted that the attack ID of the third attack is also the same as that of the past first attack in the series of attacks. Therefore, when the result of the first attack having the same attack ID indicates that the first attack is successful, the process of calculating a damage amount to the opponent object EO by the third attack may be executed, assuming that the third attack is also successful, and the damage amount by the third attack may be given to the opponent object EO.

It should be noted that for some (e.g., the second attack) of the series of attacks, the process of determining whether or not the attack is successful or the process of calculating a damage amount by the attack may not be executed. In that case, an attack (e.g., the second attack) for which the process of determining whether or not the attack is successful or the process of calculating a damage amount by the attack is not executed, may have the function of linking the preceding and succeeding attacks (e.g., the first and third attacks). As an example, after the first attack has been successfully performed, the end of the first attack may be accompanied by deletion of the attack ID thereof. In that case, if there is no second attack, no attack ID that is to be assigned to the third attack may be available at the time of assigning an attack ID. In order to avoid such a situation, an attack ID is assigned to the second attack for which the process of determining whether or not the attack is successful or the process of calculating a damage amount by the attack is not executed, whereby the attack ID assigned to the second attack that has not been ended after the end of the first attack can be passed to the third attack.

In addition, a damage amount calculated for some of the series of attacks may be zero (i.e., an attack that is successful, but does not cause damage). In that case, even when an attack is successful, the attack may not cause damage to the opponent object EO. Furthermore, when an attack is successful, then if the attack does not cause damage to the attacked object, the process of calculating a damage amount by the attack, itself, may not be executed. In addition, a series of attacks that is triggered by a single attack action and have the same attack ID may include two or four or more attacks. In addition, the order in which a plurality of attacks occur due to a single attack action may be other orders, and some of the attacks may occur at the same time. Furthermore, the details (types) of a series of attacks triggered by a single attack action are not limited to those described above, and may include other types of attacks. In addition, concerning the timing of giving a damage amount calculated for each series of attacks to an opponent object EO, damage may be caused to the opponent object EO each time an attack occurs, or damage may be caused to the opponent object EO all at once when the final one of the series of attacks occur.

The same attack ID is thus assigned and passed to a series of attacks triggered by a single attack action. Therefore, damage can be caused to an opponent object EO each time an attack occurs if the attack has the same attack ID, even during the invincibility period. Meanwhile, when another attack action is further performed, a unique attack ID is assigned to the first attack triggered by the attack action at the time of that attack. Therefore, for the first attack triggered by another attack action, it is determined whether or not the attack is successful, without association with the past attacks, and if the first attack is performed during the invincibility period, the determination of whether or not the attack is successful is not performed, and therefore, the first attack fails to cause damage to the opponent object EO. This is true of the case in which an attack action using the same weapon object or the same combination weapon object is performed again. It is determined whether or not the attack is successful, without association with any attack carried out before the attack action. As another example, it may be determined whether or not the first attack due to another attack action is successful, even during the invincibility period. In that case, even when it is determined that the first attack is successful, then if it is during the invincibility period, a damage amount due to the attack is not calculated, so that the first attack does not cause damage to the opponent object EO during the invincibility period.

Meanwhile, when different attacks that occur due to different attack actions are carried out against the same opponent object EO, different unique attack IDs are assigned to the different attacks. For example, even when these attacks seem to be a single attack (e.g., attacks carried out by a parent actor and a child actor in cooperation with each other), different attack IDs are assigned to the different attacks. Therefore, for each attack, it is independently determined whether or not the attack is successful, and a damage amount is calculated based on the result of the determination. When an attack target object is set due to some attack during the invincibility period, then if another attack occurs, the latter attack does not cause damage to the attack target object.

It should be noted that the process of assigning the same attack ID to a series of attacks triggered by a single attack action is not limited to the case in which the player object PO attacks, and may also be executed when the player object PO is attacked by another object (opponent object EO) or when other objects attack each other. For example, when an opponent object EO attacks the player object PO using a combination weapon object, the same attack ID may be assigned to each of a series of attacks triggered by an attack action using the combination weapon object, and damage may be caused, corresponding to each attack carried out against the player object PO.

In addition, in the present example, priority levels may be set for a plurality of attacks to which the same attack ID is assigned, in terms of the order in which the attack ID is assigned. For example, when some of the series of attacks newly occur in the same frame, the attack ID may be assigned to an attack having a higher priority level earlier. As a result, even when the process of assigning the same attack ID to a plurality of attacks with the same timing, then if the priority level of an attack that is subjected to the determination earlier is set relatively high, the same attack ID can be passed to the following attacks.

In addition, in the present example, the player object PO and opponent objects EO can perform the action of defending themselves against attacks from other characters and virtual objects. As an example, when the player object PO performs an attack action against an opponent object EO using a weapon according to the user's operation input, the opponent object EO can defend itself against the attack using a defensive object E for defending itself against attacks. In the present example, the player object PO and opponent objects EO can be equipped with a defensive object, and can perform a defensive action of defending itself against an attack using the attached defensive object.

In FIG. 14, an opponent object EO carries a defensive object E, and is performing a defensive action of avoiding being hit by the combination weapon object α (arrow object) projected by the player object PO, using the defensive object E. For example, when the opponent object EO defends itself by interrupting the traveling of the flying and incoming combination weapon object α projected by the player object PO, by hitting the combination weapon object α with the defensive object E, the attack by the combination weapon object α fails to cause damage to the opponent object EO.

Here, as described above, in the present example, when the player object PO performs an attack action of projecting the combination weapon object α (arrow object) at an opponent object EO, the attack action triggers a series of attacks. In addition, in the present example, the same attack ID is assigned to each of the attacks, and therefore, the result of determination of whether or not the first one of the attacks is successful is applied to the result of determination of whether or not each of the other attacks is successful. Specifically, if it is determined that defense using the defensive object E against the first one of the attacks is successful, it is determined that defenses using the defensive object E against the other attacks are successful as illustrated in FIG. 15.

In the present example, it is assumed that the same portion of a defensive object E is targeted by a plurality of attacks having the same attack ID. As an example, a portion of a defensive object E that is hit by the first one of the attacks is hit by the subsequent attacks. By thus using the same reference portion (portion hit by an attack) of a defensive object E to determine whether or not defense is successful, for a plurality of attacks, the results of defenses against the plurality of attacks can be caused to be the same. Specifically, in an attack using the combination weapon object α, when the arrow object hits a defensive object E earlier, the item object a, which subsequently explodes, may pass through the defensive object E to reach the vicinity of an opponent object EO. In that case, the item object a explodes closer to the opponent object EO than the defensive object E, so that the defensive object E is not located at a location where the defensive object E is affected by the radiation actor of a strong blast caused by the explosion, and therefore, even if the opponent object EO successfully defends itself against the attack of the arrow object using the defensive object E, the explosion may cause damage to the opponent object EO. However, the portion of the defensive object E that is hit by the arrow object and performs defense is thus used as the reference portion of the defensive object E to determine whether or not defense is successful against the radiation actor of a strong blast caused by the explosion. Therefore, even if the item object a explodes closer to the opponent object EO than the defensive object E, the same defense determination that is used for the arrow object can also be applied to the explosion of the item object a.

In the present example, for a defensive object E, a durability value indicating the durability of the defensive object E against an attack is set. For example, in the game system 1, when defense is performed against an attack using a defensive object E, the durability value of the defensive object E is reduced, depending on the strength of the attack. When the durability value is zero, the defensive object E will break (i.e., disappear). As an example, each time defense is performed against an attack using a defensive object E, the remaining durability value of the defensive object E is reduced by a value depending on the strength of the attack.

For example, FIG. 14 illustrates a gauge G indicating the remaining durability value of a defensive object E. When a series of attacks are carried out using the combination weapon object α (arrow object) projected by the player object PO's attack action, then if defense is performed against the first one of the attacks that is carried out using the arrow object, the gauge G indicates that the remaining durability value of the defensive object E is reduced by a predetermined amount. As the defense against the player object PO's attack by the defensive object E is successful, the attack fails to cause damage to the opponent object EO. It should be noted that in the example of FIG. 14, the durability value of the defensive object E remains even after the defense against the player object PO's attack, and therefore, the opponent object EO keeps carrying the defensive object E, which is not broken.

In the present example, even when a plurality of attacks occur due to a single attack action, the durability of a defensive object E that performs defense against the attacks having the same attack ID may be reduced only for a single attack instead of being reduced for each attack. For example, as illustrated in FIG. 15, the same attack ID is assigned to the second attack using the item object a included in the combination weapon object α and the third attack caused by the explosion of the item object a, which occur after the first attack or at the same time when the first attack occurs. Therefore, the result of determination of defense against the first attack using the defensive object E is applied to the second and third attacks, and therefore, the attacks fail to cause damage to the opponent object EO. However, after defense against the second and third attacks, the remaining durability value of the defensive object E is not changed, and the gauge G indicates that the remaining durability value of the defensive object E is not reduced. Thus, the result of determination of defense against a past attack (first attack) included in a series of attacks is applied to the success or failure of defense against the other attacks of the series of attacks to which the same attack ID is assigned, and the durability value of the defensive object E is not reduced. Therefore, an unrealistic impression that the durability value of the defensive object E reduces quickly and breaks easily is less likely to occur in the user.

It should be noted that when a series of attacks are triggered by a single attack action, the durability value of a defensive object E is reduced only due to the first attack, and is not reduced for the other attacks. Such a process is not limited to the case in which an opponent object EO is attacked by the player object PO, and may be executed in the case in which the player object PO and other objects are attacked or other objects attack each other. For example, when an opponent object EO attacks the player object PO having a defensive object E, using a combination weapon object, a similar process may be executed in the process of reducing the durability value of the defensive object E due to an attack action using the combination weapon object.

In addition, as described above, the success or failure of defense against the first one of the series of attacks is applied to success/failure determination for the other attacks, so that the same result is obtained in terms of the success or failure of defense against each attack. In addition, while the durability value of a defensive object E is reduced due to defense against the first one of the series of attacks, the durability value is not reduced for the other attacks. Therefore, in another example, after it is determined whether or not defense against the first one of the series of attacks is successful, the success/failure determination itself may be not performed for defense against the other attacks. For example, when defense against a past attack was successful, the success/failure determination may not be performed for defense against the current attack having the same attack ID as that of the past attack, and the current attack may not cause damage and the durability value of the defensive object E may not be reduced.

In addition, the above determination process for a series of attacks having the same attack ID may not be limited to an attack action using a combination weapon object, and may be executed for other attack actions that trigger a plurality of attacks when the attack action is performed once. For example, a similar process can be executed for an attack action that triggers a plurality of attacks that are associated with each other during a predetermined period of time and cause damage. As an example, the determination process may be executed for an attack action that causes a plurality of types of damage to the player object PO or other objects (e.g., an opponent object EO) when the attack action is performed once.

For example, in the case of an attack action that causes a lightning discharged from the sky toward the ground in the virtual space to directly hit the player object PO or other objects (e.g., an opponent object EO), a plurality of types of damage are caused to the object directly hit by the lightning. For example, as illustrated in FIG. 16, when a lightning directly hits the player object PO, damage due to hit by the body of the lightning (lightning actor), damage due to a lightning direct hit factor (chemical factor), damage due to an ignition factor (chemical factor) caused by the lightning, and damage due to an electric shock factor (chemical factor) caused by the lightning, are caused to the player object PO at the same time that the lightning action occurs or within a predetermined period of time from the lightning action. It should be noted that these types of damage may be caused to the player object PO in any order, or at least two types of damage may be simultaneously caused to the player object PO. In the description that follows, in order to provide a specific description, it is assumed that damage due to hit by the body of a lightning, damage due to a lightning direct hit factor, and damage due to an ignition factor, and damage due to an electric shock factor are caused to the player object PO in the stated order.

When such a lightning action causes a plurality of types of damage to the player object PO, the same attack ID is assigned to each of a series of attacks that cause the respective damages.

For example, when a first attack occurs which is the first one of a series of attacks triggered by the lightning action and is a lightning body (lightning actor) falling to a ground field, a unique new attack ID is assigned to the first attack. After the first attack is performed, it is determined whether or not the first attack is successful, and if the first attack is successful, a damage amount that is given to the player object PO is calculated. When the first attack is successful, the damage amount is given to the player object PO.

After the first attack caused by the lightning action, when a second attack due to a lightning direct hit factor (chemical factor) occurs against the player object PO, the same attack ID that is assigned to the past first attack of the series of associated attacks is assigned to the second attack. As the same attack ID is assigned to the first and second attacks, when the second attack is successful after the first attack is successful, a damage amount that is given to the player object PO due to the second attack (damage amount due to a lightning direct hit attribute) is calculated, and the calculated damage amount is given to the player object PO.

After the second attack, when a third attack that is generated by an ignition factor (chemical factor) caused by the lightning occurs against the player object PO, the same attack ID that is assigned to the past second attack of the series of associated attacks is assigned to the third attack. As the same attack ID is assigned to (the first attack), the second attack, and the third attack, when the third attack is successful after the second attack is successful, a damage amount that is given to the player object PO due to the third attack (damage amount due to an ignition attribute) is calculated, and the calculated damage amount is given to the player object PO.

After the third attack, when a fourth attack that is generated by an electric shock factor (chemical factor) caused by the lightning occurs against the player object PO, the same attack ID that is assigned to the past third attack of the series of associated attacks is assigned to the fourth attack. As the same attack ID is assigned to (the first and second attacks), the third attack, and the fourth attack, when the fourth attack is successful after the third attack is successful, a damage amount that is given to the player object PO due to the fourth attack (damage amount due to an electric shock attribute) is calculated, and the calculated damage amount is given to the player object PO. Thus, the same attack ID is assigned to all of a series of attacks triggered by a single lightning action.

Thus, the same attack ID is assigned to all attacks that are triggered by a single lightning action and cause a plurality of types of damage, and the damage calculation process is executed for each of the attacks having the same attack ID. Therefore, damage can be caused to the player object PO based on the determination process for each type of attack even during the invincibility period.

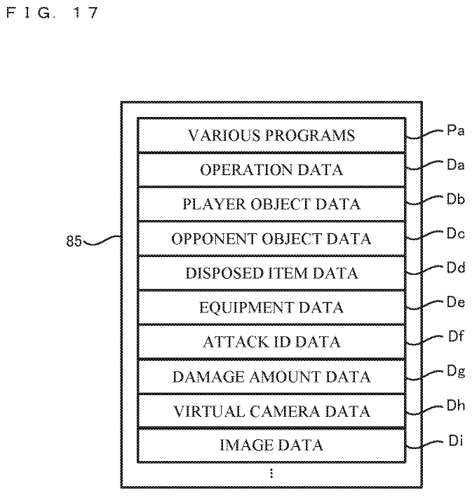

Next, an example of a specific process that is executed in the game system 1 will be described with reference to FIG. 17. FIG. 17 is a diagram illustrating an example of a data area set in the DRAM 85 of the main body apparatus 2. It should be noted that in addition to the data of FIG. 17, the DRAM 85 also stores data used in other processes, which will not be described in detail.

Various programs Pa that are executed in the game system 1 are stored in a program storage area of the DRAM 85. In the present example, the programs Pa include an application program (e.g., a game program) for performing information processing based on data obtained from the left controller 3 and/or the right controller 4 and the main body apparatus 2, and the like. Note that the programs Pa may be previously stored in the flash memory 84, may be obtained from a storage medium removably attached to the game system 1 (e.g., a predetermined type of storage medium attached to the slot 23) and then stored in the DRAM 85, or may be obtained from another apparatus via a network, such as the Internet, and then stored in the DRAM 85. The processor 81 executes the programs Pa stored in the DRAM 85.

In addition, the data storage area of the DRAM 85 stores various kinds of data that are used in processes that are executed in the game system 1 such as information processes. In the present example, the DRAM 85 stores operation data Da, player object data Db, opponent object data Dc, disposed item data Dd, equipment data De, attack ID data Df, damage amount data Dg, virtual camera data Dh, image data Di, and the like.

The operation data Da is obtained, as appropriate, from each of the left controller 3 and/or the right controller 4 and the main body apparatus 2. As described above, the operation data obtained from each of the left controller 3 and/or the right controller 4 and the main body apparatus 2 includes information about an input from each input section (specifically, each button, an analog stick, or a touch panel) (specifically, information about an operation). In the present example, operation data is obtained from each of the left controller 3 and/or the right controller 4 and the main body apparatus 2. The obtained operation data is used to update the operation data Da as appropriate. It should be noted that the operation data Da may be updated for each frame that is the cycle of a process executed in the game system 1, or may be updated each time operation data is obtained.

The player object data Db indicates the location, direction, and pose of a player object PO that is disposed in the virtual space, and the player object PO's action, state (including the life value, or data indicating whether or not it is during the invincibility period), and the like in the virtual space. In addition, when the player object PO uses a weapon object, a combination weapon object, or a defensive object, the player object data Db also indicates the location, direction, orientation, and the like of these objects that are being used by the player object PO.

The opponent object data Dc indicates the location, direction, and pose of an opponent object EO that is disposed in the virtual space, and the opponent object EO's action, state (including the life value, or data indicating whether or not it is during the invincibility period), and the like in the virtual space. In addition, when the opponent object EO uses a weapon object, a combination weapon object, or a defensive object, the opponent object data Dc also indicates the location, direction, orientation, and the like of these objects that are being used by the opponent object EO.

The disposed item data Dd indicates the location and type of an item object(s) disposed on a game field.

The equipment data De indicates weapon objects, combination weapon objects, and defensive objects with which the player object PO and other objects (e.g., an opponent object EO) are currently equipped, and any of the objects that is being used (or being held) by the player object PO or another object, and a state thereof (including the configuration or durability value of the object being used).

The attack ID data Df indicates an attack ID that is assigned to each attack that newly occurs. It should be noted that an attack ID may be managed for each attack action that currently occurs.

The damage amount data Dg indicates a calculated damage amount caused by an attack.

The virtual camera data Dh indicates the location, orientation, angle of view, and the like of a virtual camera disposed in the virtual space.

The image data Di is used to display, on a display screen (e.g., the display 12 of the main body apparatus 2), images (e.g., an image of the player object PO, an image of an opponent object EO, images of other characters, images of various objects such as weapon objects, defensive object, and item objects, an image of a field in the virtual space, and a background image).

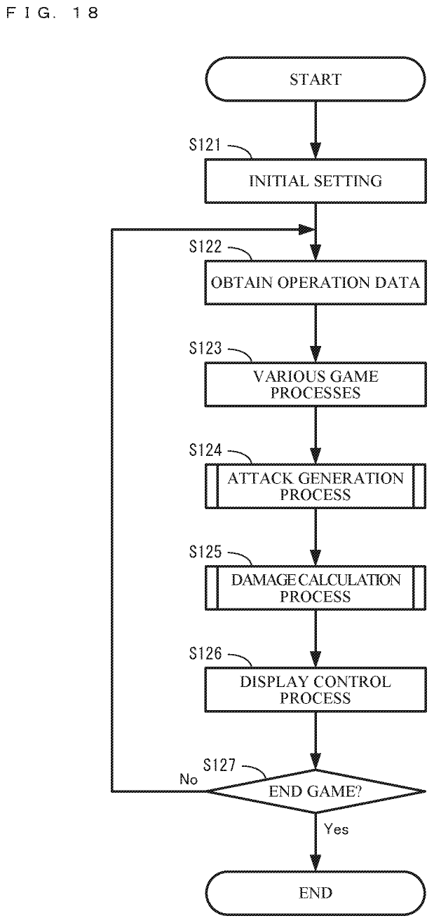

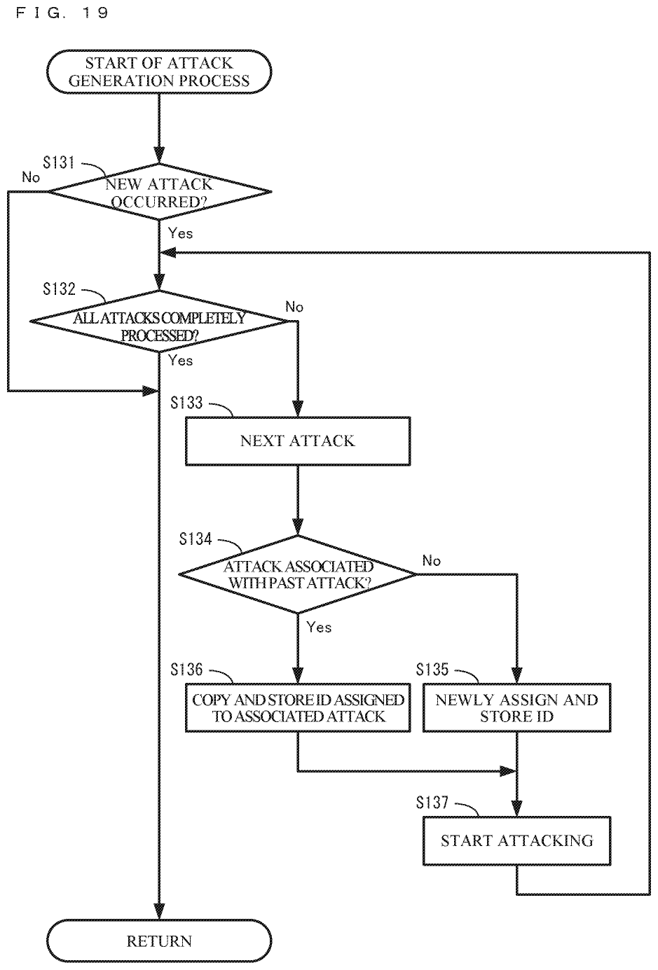

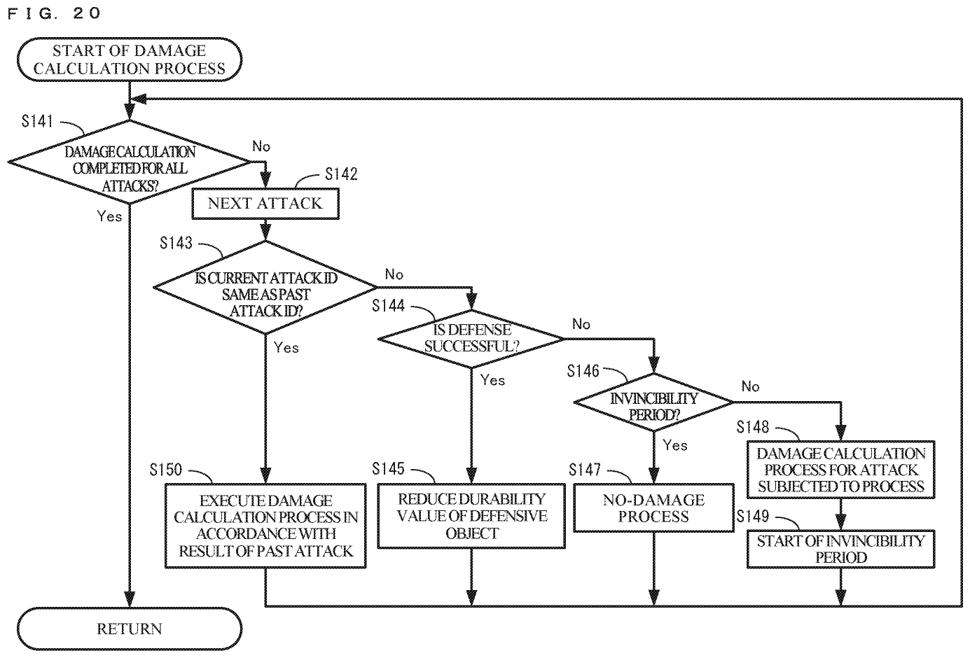

Next, a detailed example of a game process that is an example of an information process in the present example will be described with reference to FIGS. 18 to 20. FIG. 18 is a flowchart illustrating an example of a game process that is executed in the game system 1. FIG. 19 is a subroutine illustrating an example of an attack generation process in step S124 of FIG. 18. FIG. 20 is a subroutine illustrating an example of a damage calculation process in step S125 of FIG. 18. In the present example, a series of steps illustrated in FIGS. 18 to 20 are executed by the processor 81 executing a predetermined application program (game program) included the programs Pa. The game process of FIGS. 18 to 20 is started with any appropriate timing.

It should be noted that the steps in the flowcharts of FIGS. 18 to 20, which are merely illustrative, may be executed in a different order, or another step may be executed in addition to (or instead of) each step, if a similar effect is obtained. In the present example, it is assumed that the processor 81 executes each step of the flowcharts. Alternatively, a portion of the steps of the flowcharts may be executed by a processor or dedicated circuit other than the processor 81. In addition, a portion of the steps executed by the main body apparatus 2 may be executed by another information processing apparatus that can communicate with the main body apparatus 2 (e.g., a server that can communicate with the main body apparatus 2 via a network). Specifically, the steps of FIGS. 18 to 20 may be executed by a plurality of information processing apparatuses including the main body apparatus 2 cooperating with each other.

In FIG. 18, the processor 81 performs initial setting for the game process (step S121), and proceeds to the next step. For example, in the initial setting, the processor 81 initializes parameters for performing steps described below, and updates each data. As an example, the processor 81 disposes various objects, characters, and the like on a game field in a virtual space to generate an initial state of the virtual space, and updates the disposed item data Dd. In addition, the processor 81 disposes a player object PO, an opponent object EO, and a virtual camera in predetermined poses or orientation at default locations in the virtual space in the initial state, and updates the player object data Db, the opponent object data Dc, and the virtual camera data Dh.

Next, the processor 81 obtains operation data from the left controller 3, the right controller 4, and/or the main body apparatus 2, updates the operation data Da (step S122), and proceeds to the next step.

Next, the processor 81 executes various game processes (step S123), and proceeds to the next step. For example, the processor 81 updates the player object data Db, the opponent object data Dc, and the disposed item data Dd based on a process executed according to the operation data Da, progression of animation, physical calculation and AI control in the virtual space, and the like, and thereby updates characters disposed in the virtual space such as the player object PO and the opponent character EO, and objects disposed in the virtual space such as item objects. In addition, the processor 81 causes the player object PO to be equipped with a weapon object, a combination weapon object, a defensive object, and the like, based on the equipment data De. In addition, the processor 81 updates the virtual camera data Dh according to control based on the operation data Da, control based on the location or pose of the player object PO, or the like, and thereby updates the location and/or orientation of the virtual camera for generating a display image.

As a first example of various game control processes in step S123, the processor 81 executes a player object action process. For example, the processor 81 sets an action of the player object PO based on the operation data Da. As an example, the processor 81 sets the location, direction, pose, action, state, and the like of the player object PO based on the user's operation input indicated by the operation data Da and virtual physical calculation (e.g., virtual inertia and gravity) in the virtual space, and the like, and updates the player object data Db.

The action of the player object PO includes an action that is performed using a weapon object, a combination weapon object, a defensive object, or the like. For example, if the user performs an operation input to change weapon objects, combination weapon objects, or defensive objects with which the player object PO is equipped, the processor 81 changes the weapon object, combination weapon object, or defensive object carried by the player object PO according to the operation input, and updates the equipment data De based on the change. In addition, if the user performs an operation input for performing an attack action, the processor 81 causes the player object PO to perform the action of using the weapon object, combination weapon object, or defensive object based on the equipment data De (e.g., attacking by swinging a weapon object or combination weapon object being held, or defending itself against an attack using a defensive object being held), and updates the player object data Db.

As a second example of various game control processes in step S123, the processor 81 executes an other-character action process. For example, the processor 81 controls actions of objects (e.g., an opponent object EO) other than the player object PO according to rules previously determined in the game program, and updates the opponent character data Dc.

The action of the opponent object EO includes an action that is performed using a weapon object, a combination weapon object, a defensive object, or the like. For example, if the opponent object EO performs the action of changing weapon objects, combination weapon objects, or defensive objects with which the opponent object EO is equipped, the processor 81 changes the weapon object, combination weapon object, or defensive object carried by the opponent object EO according to the action, and updates the equipment data De based on the change. In addition, if the opponent object EO performs an attack action, the processor 81 causes the opponent object EO to perform the action of using the weapon object, combination weapon object, or defensive object based on the equipment data De (e.g., attacking by swinging a weapon object or combination weapon object being held, or defending itself against an attack using a defensive object being held), and updates the opponent object data Dc.

As a third example of various game control processes in step S123, the processor 81 executes a weapon synthesis process if the player object PO is performing an action that allows generation of a combination weapon object. For example, if the player object PO is allowed to use an item object and is holding a weapon object in a game, the processor 81 executes the weapon synthesis process. For example, the processor 81 designates an item object to be subjected to the weapon synthesis process from item objects stored by the player object PO or item objects on a game field (terrain object L) based on the operation data Da, and combines the weapon object carried by the player object PO with the item object of interest to generate a combination weapon object. Thereafter, the processor 81 changes the weapon object of interest carried by the player object PO into the combination weapon object (see FIG. 9), and updates the equipment data De and the disposed item data Dd based on the change.

It should be noted that in the weapon synthesis process, a scene may be displayed in which the item object of interest and the weapon object are controlled such that the item object of interest approaches the weapon object, and thereafter, disappears, and the weapon object of interest, which is carried by the player object PO, is changed into a combination weapon object.

As a fourth example of various game control processes in step S123, the processor 81 executes a process of causing the player object PO to obtain an item object or a weapon object based on the operation data Da. For example, the processor 81 additionally stores an item object or a weapon object obtained by the player object PO performing the action of obtaining the item object or the weapon object, into the player object PO.

Next, the processor 81 executes an attack generation process (step S124), and proceeds to step S125. The attack generation process in step S124 will be described below with reference to FIG. 19.

In FIG. 19, the processor 81 determines whether or not a new attack has occurred (step S131). For example, the processor 81 determines whether or not the player object PO or an opponent object EO has carried out a new attack, with reference to the player object data Db and the opponent object data Dc. If a new attack has occurred, the processor 81 proceeds to step S132. Otherwise, i.e., if a new attack has not occurred, the processor 81 ends the subroutine. As an example, in step S131, if the user's operation input has been performed to cause the player object PO or an opponent object EO to perform a new attack action (e.g., the player object PO's action of holding a sword, starting swinging a sword, holding an arrow, or shooting an arrow), or if a phenomenon (e.g., explosion or electric discharge) has occurred which causes a weapon object or combination weapon object (item object) used in an attack to attack an attack target object, or the like, it is determined that a new attack has occurred. As another example, in step S131, if a weapon object or combination weapon object (item object) used in an attack is being moved for an attack, if a weapon object or combination weapon object (item object) used in an attack has newly hit an attack target object, or if a radiation object (radiation actor) generated by the phenomenon for attacking an attack target object has newly hit an attack target object, or the like, it is determined that a new attack has occurred. It should be noted that if the same object that is used in an attack has hit an attack target object again, or if a radiation object (radiation actor) generated by the same phenomenon has hit an attack target object again, the processor 81 does not determine that a new attack has occurred.

In step S132, the processor 81 determines whether or not the process has been completed for all attacks that it was determined in step S131 that had newly occurred. When the process has not been completed for all attacks, the processor 81 proceeds to step S133. Otherwise, i.e., if the process has been completed for all attacks, the processor 81 ends the subroutine.

In step S133, the processor 81 chooses one for which the process has not been completed, from the attacks that it was determined in step S131 that had newly occurred, and proceeds to the next step.

It should be noted that if there are a plurality of attacks that it is determined that have newly occurred, and the plurality of attacks include some attacks that are associated with each other, the processor 81 processes an attack having a higher priority level earlier in step S133. For example, if at least two of the first to third attacks described above are included in the attacks that it is determined that have newly occurred, the processor 81 processes one having a higher priority level than that of another one of the first to third attacks earlier. By executing the process using such priority levels, an attack ID can be assigned to one having a higher priority level than that of another one of the attacks associated with each other earlier, and therefore, the same attack ID can be passed to the following attacks.

Next, the processor 81 determines whether or not the process is related to an attack associated with a past attack to which an attack ID has already been assigned (step S134). For example, if the attack ID data Df indicates that an attack ID has already been assigned to an attack associated with another attack that is currently subjected to the process, the result of the determination by the processor 81 in step S134 is positive. For example, the processor 81 determines that a series of attacks triggered by a single attack action are associated with each other, and determines whether or not the process is related to an attack associated with a past attack corresponding to a weapon object or the like remaining as data in the current frame. If the process is not related to an attack associated with a past attack to which an attack ID has already been assigned, the processor 81 proceeds to step S135. Otherwise, i.e., if the process is related to an attack associated with a past attack to which an attack ID has already been assigned, the processor 81 proceeds to step S136.

In step S135, the processor 81 newly assigns a unique attack ID to the attack that is currently subjected to the process, updates the attack ID data Df, and proceeds to step S137. For example, if the player object PO performs an attack action using the combination weapon object α (see FIGS. 11 to 13), and the first attack of shooting the arrow object at an opponent object EO, which is generated based on the attack action, is currently subjected to the process, the processor 81 assigns a new attack ID to the first attack, and stores the attack ID.

Meanwhile, in step S136, the processor 81 copies and assigns an attack ID that has been assigned to an attack associated with the attack that is currently subjected to the process, to the attack that is currently subjected to the process, updates the attack ID data Df, and proceeds to step S137. As an example, if the player object PO has performed an attack action using the combination weapon object α (see FIGS. 11 to 13), and the second attack which is generated based on the attack action and in which the item object a hits an opponent object EO is currently subjected to the process, the processor 81 assigns the same attack ID that has already been assigned to the first attack, which is associated with the second attack, to the second attack, and stores the attack ID. As another example, if the player object PO has performed an attack action using the combination weapon object α (see FIGS. 11 to 13), and the third attack that is generated based on the attack action and is caused by the explosion of the item object a is currently subjected to the process, the processor 81 assigns the same attack ID that has already been assigned to the first or second attack, which are associated with the third attack, to the third attack, and stores the attack ID.

In step S137, the processor 81 starts the attack that is currently subjected to the process, based on the attack ID assigned thereto, and returns to and repeats step S132. It should be noted that the assigned and stored attack ID may be deleted from the attack ID data Df if the weapon object or item object that has been used in an attack having the assigned attack ID is removed from the virtual space, if the attack is ended, or if the attack action that has triggered the attack is ended.

Referring back to FIG. 18, the processor 81 executes a damage calculation process (step S125) after the attack generation process in step S124, and proceeds to step S126. The damage calculation process in step S125 will be described below with reference to FIG. 20.

In FIG. 20, the processor 81 determines whether or not the damage calculation process has been completed for all attacks that are subjected thereto (step S141). If the damage calculation process has not been completed for all attacks that are subjected thereto, the processor 81 proceeds to step S142. Otherwise, i.e., if the damage calculation process has been completed for all attacks that are subjected thereto, the processor 81 ends the subroutine. Here, attacks that are subjected to the damage calculation process include some of the attacks that it is determined in step S131 that have newly occurred, that newly have an effect on an attack target object, such as an attack in which a weapon object, combination weapon object, and item object for the attack, a part of the body of the player object PO for the attack, or the like has newly hit an attack target object (e.g., an opponent object EO) or an object with which the attack target object is equipped, and an attack in which a projected object (radiation actor) projected due to a phenomenon (e.g., explosion or electric discharge) caused by the function of an item object (including an item object included in a combination weapon object) or the like for the attack has newly hit an attack target object or an object with which the attack target object is equipped.

In step S142, the processor 81 chooses an attack for which the damage calculation process has not been completed from those that are subjected to the damage calculation process, and proceeds to the next step.

Next, the processor 81 determines whether or not the attack ID that is assigned to the attack that is currently subjected to the process is the same as the attack ID that is assigned to a past attack, with reference to the attack ID data Df (step S143). If the attack ID that is assigned to the attack that is currently subjected to the process is not the same as the attack ID that is assigned to a past attack, the processor 81 proceeds to step S144. Otherwise, i.e., if the attack ID that is assigned to the attack that is currently subjected to the process is the same as the attack ID that is assigned to a past attack, the processor 81 proceeds to step S150. As a first example, if the first attack of shooting an arrow object at an opponent object EO, which is triggered by the player object PO's attack action using the combination weapon object α (see FIGS. 11 to 13), is currently subjected to the process, no other attack associated with the first attack has been carried out before the first attack, and there is no past attack that has the same attack ID as that of the first attack (i.e., none of the attack IDs of past attacks, if any, is the same as that of the first attack), and therefore, the result of the determination by the processor 81 in step S143 is negative. As a second example, if the second attack in which the item object a generated based on the above attack action hits an opponent object EO is currently subjected to the process, the first attack, which is associated with the second attack, has been performed before the second attack, and the attack ID of the second attack is the same as that of the first attack, and therefore, the result of the determination by the processor 81 in step S143 is positive. As a third example, if the third attack caused by the explosion of the item object a generated based on the above attack action is currently subjected to the process, the second attack, which is associated with the third attack, has been performed before the third attack, and the attack ID of the third attack is the same as that of the second attack, and therefore, the result of the determination by the processor 81 in step S143 is positive.

In step S144, the processor 81 executes control determination for the attack that is currently subjected to the process. For example, if an attack target object (e.g., an opponent object EO) has defended itself against the attack carried out by the player object PO that is currently subjected to the process, using a defensive object, the result of the determination by the processor 81 in step S144 is positive. As an example, if an object, a part of the body, or the like that is used in an attack by the player object PO has hit a defensive object E carried by an attack target object, the processor 81 determines that the attack target object has defended itself against the attack using the defensive object E. If the attack target object has defended itself against the attack that is currently subjected to the process, the processor 81 proceeds to step S145. Otherwise, i.e., if the attack target object has not defended itself against the attack that is currently subjected to the process, the processor 81 proceeds to step S146.

In step S145, the processor 81 reduces the durability value of the defensive object E used for defense against the attack, and returns to and repeats step S141. As an example, the processor 81 may reduce the durability value of the defensive object E used for defense against an attack, depending on the strength (the level of offensive strength) of the attack against which defense has been performed, and update the equipment data De. As another example, the processor 81 may reduce the durability value of the defensive object E used for defense against an attack by a predetermined value each time defense is performed against an attack, irrespective of the strength (the level of offensive strength) of an attack against which defense is performed (e.g., the initial durability value is 30, and is reduced by one each time an attack is performed), and updates the equipment data De. In addition, if the durability value of a defensive object E used for defense against an attack is zero, the processor 81 displays a scene in which the defensive object E is broken and then a scene in which the defensive object E disappears from the virtual space. The scene in which a defensive object E disappears proceeds as step S123 is repeatedly executed. It should be noted that if step S145 is executed, an attack target object that defends itself against an attack that is currently subjected to the process may be set to the invincibility state, and the invincibility period may be started. In that case, after step S145, step S149 described below may be executed.

Meanwhile, in step S146, the processor 81 determines whether or not the attack target object (e.g., an opponent object EO) against which the attack that is currently subjected to the process is carried out is during the invincibility period, with reference to the opponent object data Dc. If the attack target object is during the invincibility period, the processor 81 proceeds to step S147. Otherwise, i.e., if the attack target object is not during the invincibility period, the processor 81 proceeds to step S148.

In step S147, the processor 81 executes a no-damage process that allows the attack target object or an object with which the attack target object is equipped to be free from damage or a reduction in durability value due to the attack that is currently subjected to the process, and thereby maintain the current state, and returns to and repeats step S141. By this process, if the attack target object is during the invincibility period, an attack having an attack ID that is not the same as that of a past attack does not cause damage to the attack target object.

Meanwhile, in step S148, the processor 81 calculates a damage amount for the attack that is currently subjected to the process, and proceeds to the next step. For example, the processor 81 calculates a damage amount that is given to the attack target object if the attack that is currently subjected to the process is successful, and updates the damage amount data Dg. Thereafter, the processor 81 reduces the life value of the attack target object by a predetermined amount based on the calculated damage amount, and updates the opponent object data Dc using the reduced life value.

Next, the processor 81 sets the attack target object that has come under the attack that is currently subjected to the process to the invincibility state, starts the invincibility period, and updates the opponent object data Dc (step S149), and returns to and repeats step S141. For example, the processor 81 sets a period of time that continues until a predetermined time (e.g., 30 frames) has passed, as the invincibility period, and performs control such that if the attack target object that has come under the attack that is currently subjected to the process comes under another attack during the invincibility period, the latter attack does not cause damage to the attack target object. It should be noted that if the life value of the attack target object that has come under the attack that is currently subjected to the process is zero in step S148, the processor 81 may cause the attack target object to disappear from the virtual space, and update the opponent object data Dc. In addition, the presence or absence and length of the invincibility period may be set, depending on the type of an attack target object. As an example, the invincibility period may be set only for the player object PO, but not for other characters such as opponent objects EO.

In step S143, if it is determined that the attack ID assigned to the attack that is currently subjected to the process is the same as that assigned to a past attack, the processor 81 executes a damage calculation process in accordance with the result of the past attack having the same attack ID (step S150), and returns to and repeats step S141. As a first example, if the result of the past attack having the same attack ID has caused damage to the attack target object, the processor 81 calculates a damage amount to the attack target object due to the attack that is currently subjected to the process, and updates the damage amount data Dg. Thereafter, the processor 81 reduces the life value of the attack target object by a predetermined amount based on the calculated damage amount, and updates the opponent object data Dc using the reduced life value. If the life value is zero, the processor 81 causes the attack target object to disappear from the virtual space. In the first example, an attack having the same attack ID as that assigned to a past attack causes damage to the attack target object even if the attack target object is during the invincibility period. As a second example, if the attack target object defended itself against a past attack having the same attack ID, it is determined that the attack target object also has defended itself against the attack that is currently subjected to the process, and damage is not caused to the attack target object, and the life value of the attack target object is maintained. Although in the second example it is determined that the attack target object also has defended itself against the attack that is currently subjected to the process, the durability value of a defensive object E that was used for the defense is maintained without a reduction. As a third example, if a past attack having the same attack ID was carried out during the invincibility period of the attack target object and therefore the no-damage process was executed, the no-damage process is also executed for the attack that is currently subjected to the process against the attack target object.

As an example, in step S150, if the second attack in which the item object a generated based on the player object PO's attack action using the combination weapon object α (see FIGS. 11 to 13) hits the attack target object is currently subjected to the process, the result of the determination of whether or not damage is caused due to the second attack is similar to the result of the determination of whether or not damage is caused due to the first attack that is associated with the second attack and has already been carried out against the attack target object. In addition, if the third attack caused by the explosion of the item object a generated based on the attack action is currently subjected to the process, the result of the determination of whether or not damage is caused due to the third attack is similar to the result of the determination of whether or not damage is caused due to the second attack that is associated with the third attack and has already been carried out against the attack target object (or the result of the determination of whether or not damage is caused to the first attack).

Referring back to FIG. 18, the processor 81 executes a display control process (step S126) after the damage calculation process in step S125, and proceeds to the next step. For example, the processor 81 performs control so as to generate an image of the virtual space in which the player object PO, opponent objects EO, and objects are disposed based on the player object data Db, the opponent object data Dc, and the disposed item data Dd, as viewed from the virtual camera based on the virtual camera data Dh, and display the image of the virtual space on the display 12. In addition, the processor 81 may generate user interface (UI) images showing the life values of the player object PO, opponent objects EO, and the like based on the player object data Db and the opponent object data Dc, and display the images in the vicinity of the respective objects. The UI image may be displayed, overlaying the image of the virtual space, or may be disposed in the virtual space and therefore may be displayed as an image of the virtual space as viewed from the virtual camera. It should be noted that the processor 81 may execute a process of controlling movement of the virtual camera in the virtual space based on the location and pose of the player object PO, and update the virtual camera data Dh. In addition, the processor 81 may move the virtual camera in the virtual space based on the operation data Da, and update the virtual camera data Dh.

Next, the processor 81 determines whether or not to end the game process (step S127). In step S127, the game process is ended, for example, if a condition for ending the game process is satisfied, the user has performed an operation of ending the game process, or the like. If the processor 81 determines not to end the game process, the processor 81 returns to step S122, and repeats the process. Otherwise, i.e., if the processor 81 determines to end the game process, the processor 81 ends the flowchart. Following this, steps S122 to S127 are repeatedly executed until the processor 81 determines to end the game process in step S127.

In the foregoing, the flow of the game process has been described with reference to FIGS. 18 to 20 using the example in which the player object PO mainly has an offensive role. Alternatively, the game process can be executed based on the above flowchart even when the player object PO has a defensive role. As described above, in the present example, the player object PO may come under an attack from other objects (e.g., opponent objects EO), i.e., the player object PO may be an attack target object. For example, the player object PO's defensive action that is performed based on the user's operation input may be set in step S123. Thereafter, determination of whether or not the player object PO's defensive action is successful and calculation of a damage amount given to the player object PO may be executed in step S125, and the player object data Db may be updated as appropriate.

Thus, in the present example, when an attack target object comes under a plurality of attacks, the case can be avoided in which one of the attacks that have hit the attack target object is determined to be successful and causes damage, and thereafter, other attacks that hit the attack target object do not cause damage. As a result, the user is less likely to have unrealistic impression when a plurality of attacks are carried out. For example, by assigning the same attack ID to all of a series of attacks triggered by a single attack action, damage calculation can be executed based on each attack.

It should be noted that in the present example, attacks ID may have different priority levels. As an example, when the same attack target object comes under a plurality of attacks in the same frame, the success/failure determination process and the damage calculation process may be executed for an attack having an attack ID with the highest priority level, and no damage may be caused due to the other attacks having an attack ID with a relatively low priority level. In that case, in step S146, when the same attack target object that comes under the attack that is subjected to the process comes under the other attacks in the same frame, the process may be carried out by negative determination for attacks having an attack ID with a higher priority level and positive determination for attacks having an attack ID with a lower priority level. As another example, during the time when an attack target object is under a series of attacks triggered by a single attack action, if the same attack target object comes under an attack caused by another attack action, the success/failure determination process and the damage calculation process may be executed for an attack having an attack ID with the highest priority level, and no damage may be caused due to the other attacks having an attack ID with a relatively low priority level. For example, by setting the priority level of the attack ID assigned to the series of attacks to a relatively high value, the damage calculation process can be executed for the series of attacks with higher priority even when the series of attacks are interrupted by another attack. In that case, in step S146, during the time when the same attack target object that is under an attack that is subjected to the process is under the series of attacks that are different from said attack, the process may be carried out by positive determination for the attack that is subjected to the process and has an attack ID with a lower priority level.

In addition, in the foregoing, by assigning the same attack ID, the effect of enabling the success/failure determination and damage calculation process for a plurality of attacks is obtained. However, the method for obtaining such an effect is not limited to the process of assigning the same attack ID. For example, when an attack is performed against an attack target object using a combination weapon object obtained by combining a weapon object with an item object, an attack using the weapon object and an attack using the item object are defined in association with each other, and are each performed against the attack target object. In that case, when success/failure determination is performed on one of the attack using the weapon object and the attack using the item object, and the one attack is successful, the one attack causes damage to the attack target object, and the other of the attack using the weapon object and the attack using the item object, which is associated with the one attack, is determined to be successful, and causes damage to the attack target object. Thus, even in such a process without using an attack ID, if attacks are defined in association with each other, the attacks can be handled as a single attack group, and damage calculation can be executed based on each attack.

In addition, in the above example, the player object PO uses an item object in an attack action. An item object may be used in other actions. In addition, an item object may be used not only in synthesis of a combination weapon object but also in other forms. For example, the player object PO may be able to perform the action of moving, carrying an item object alone, and the action of throwing an item object alone. It should be noted that the action of throwing an item object alone may be performed so as to throw the item object alone so that the item object hits an attack target object, and therefore, may be included in the above attack action.

The game system 1 may be any suitable apparatus, including handheld game apparatuses, personal digital assistants (PDAs), mobile telephones, personal computers, cameras, tablet computers, and the like.

In the foregoing, the information process (game process) is performed in the game system 1 by way of example. Alternatively, at least a portion of the process steps may be performed in another apparatus. For example, when the game system 1 can also communicate with another apparatus (e.g., a server, another information processing apparatus, another image display apparatus, another game apparatus, another mobile terminal, etc.), the process steps may be executed in cooperation with the second apparatus. By thus causing another apparatus to perform a portion of the process steps, a process similar to the above process can be performed. The above information process may be executed by a single processor or a plurality of cooperating processors included in an information processing system including at least one information processing apparatus. In the above example, the information processes can be performed by the processor 81 of the game system 1 executing predetermined programs. Alternatively, all or a portion of the above processes may be performed by a dedicated circuit included in the game system 1.

Here, according to the above variation, the present example can be implanted in a so-called cloud computing system form or distributed wide-area and local-area network system forms. For example, in a distributed local-area network system, the above process can be executed by cooperation between a stationary information processing apparatus (a stationary game apparatus) and a mobile information processing apparatus (handheld game apparatus). It should be noted that, in these system forms, each of step S may be performed by substantially any of the apparatuses, and the present example may be implemented by assigning the steps to the apparatuses in substantially any manner.

The order of steps, setting values, conditions for determination, etc., used in the above information process are merely illustrative, and of course, other order of steps, setting values, conditions for determination, etc., may be used to implement the present example.

The above programs may be supplied to the game system 1 not only through an external storage medium, such as an external memory, but also through a wired or wireless communication line. The program may be previously stored in a non-volatile storage device in the game system 1. Examples of an information storage medium storing the program include non-volatile memories, and in addition, CD-ROMs, DVDs, optical disc-like storage media similar thereto, and flexible disks, hard disks, magneto-optical disks, and magnetic tapes. The information storage medium storing the program may be a volatile memory storing the program. Such a storage medium may be said as a storage medium that can be read by a computer, etc. (computer-readable storage medium, etc.). For example, the above various functions can be provided by causing a computer, etc., to read and execute programs from these storage media.

While several example systems, methods, devices, and apparatuses have been described above in detail, the foregoing description is in all aspects illustrative and not restrictive. It should be understood that numerous other modifications and variations can be devised without departing from the spirit and scope of the appended claims. It is, therefore, intended that the scope of the present technology is limited only by the appended claims and equivalents thereof. It should be understood that those skilled in the art could carry out the literal and equivalent scope of the appended claims based on the description of the present example and common technical knowledge. It should be understood throughout the present specification that expression of a singular form includes the concept of its plurality unless otherwise mentioned. Specifically, articles or adjectives for a singular form (e.g., “a”, “an”, “the”, etc., in English) include the concept of their plurality unless otherwise mentioned. It should also be understood that the terms as used herein have definitions typically used in the art unless otherwise mentioned. Thus, unless otherwise defined, all scientific and technical terms have the same meanings as those generally used by those skilled in the art to which the present example pertain. If there is any inconsistency or conflict, the present specification (including the definitions) shall prevail.

As described above, the present example is applicable as a game program, game system, game apparatus, game processing method, and the like that are capable of, when a plurality of attacks occur in a virtual space, executing damage calculation and the like based on the attacks.

What is claimed is:

1. A non-transitory computer-readable storage medium having stored therein instructions that, when executed, cause one or more processors of an information processing apparatus to execute game processing comprising:
executing an attack generation process of generating at least one attack in a virtual space, and assigning an ID to each attack, based on a game process; and
when the attack hits an object in the virtual space, determining that the attack is successful, and executing a damage calculation process of calculating damage caused by the attack, wherein
in the damage calculation process, when an attack having an ID that is the same as the ID assigned to a past attack that has hit the object hits the object, damage is caused due to the attack having the same ID.

2. The non-transitory computer-readable storage medium according to claim 1, wherein
in the damage calculation process,
when an attack having an ID that is different from the ID assigned to a past attack that has hit the object due to the attack hits the object, damage due to the attack having the different ID is forbidden to occur during a period of time from the past attack, and
when an attack having an ID that is the same as the ID assigned to a past attack that has hit the object due to the attack hits the object during the period of time, damage is caused due to the attack having the same ID.

3. The non-transitory computer-readable storage medium according to claim 1, wherein
the game processing further comprises:
executing a character control process of controlling a character that is the object in the virtual space, and
in the damage calculation process, in an attack that is against the character and has an ID that is the same as the ID assigned to a past attack that it is determined that the character has successfully defended itself against using a defensive object with which the character is equipped, damage to the character due to the attack having the same ID is forbidden to occur.

4. The non-transitory computer-readable storage medium according to claim 1, wherein
the game processing further comprises:
executing a character control process of controlling a character that is the object equipped with a defensive object having a durability value that is reduced each time defense is successful against the attack in the virtual space, and
in the character control process, when an attack having an ID that is the same as the ID assigned to a past attack that it is determined that the character has successfully defended itself against using the defensive object and that has reduced the durability value hits the defensive object, a reduction in the durability value due to the attack having the same ID is forbidden to occur.

5. The non-transitory computer-readable storage medium according to claim 1, wherein
the game processing further comprises:
executing a character control process of controlling a character in the virtual space,
in the attack generation process, when the character is caused to perform the attack using a combination weapon object obtained by combining a weapon object with an item object, in the attack an attack using the weapon object and an attack using the item object are generated, and the same ID is assigned to the attack using the weapon object and the attack using the item object, and
in the damage calculation process, when it is determined that one of the attack using the weapon object and the attack using the item object is successful, and damage is caused to the object due to the one attack, damage is further caused due to the other of the attack using the weapon object and the attack using the item object.

6. The non-transitory computer-readable storage medium according to claim 1, wherein
in the attack generation process,
a series of attacks that are a first attack, a second attack, and a third attack are generated according to a user's attack command input,
a first ID is assigned to the first attack according to the attack command input,
a second ID that is the same as the first ID is assigned to the second attack associated with the first attack at the time of the first attack or after the first attack occurs, and
a third ID that is the same as the second ID is assigned to the third attack associated with the second attack after the first attack occurs, at the time of the second attack, or after the second attack occurs, and
in the damage calculation process, when the attack having the first ID and/or the attack having the second ID hit the object, damage is caused due to the attack having the third ID.

7. A non-transitory computer-readable storage medium having stored therein instructions that, when executed, cause one or more processors of an information processing apparatus to execute game processing comprising:
executing a character control process of controlling a character in a virtual space;
executing an attack generation process of causing the character to perform an attack using a weapon object that the character is allowed to carry; and
when the attack hits an object disposed in the virtual space, determining that the attack is successful, and executing a damage calculation process of calculating damage caused by the attack,
wherein
in the attack generation process, when the character is caused to perform the attack using a combination weapon object obtained by combining the weapon object with an item object, in the attack an attack using the weapon object and an attack using the item object are generated, and
in the damage calculation process, when it is determined that one of the attack using the weapon object and the attack using the item object is successful, and damage is caused to the object due to the one attack, damage is further caused due to the other of the attack using the weapon object and the attack using the item object.

8. A game system comprising:
one or more processors; and
one or more memories storing instructions that, when executed, cause the game system to perform operations including:
executing an attack generation process of generating at least one attack in a virtual space, and assigning an ID to each attack, based on a game process; and
when the attack hits an object in the virtual space, determining that the attack is successful, and executing a damage calculation process of calculating damage caused by the attack,
wherein
in the damage calculation process, when an attack having an ID that is the same as the ID assigned to a past attack that has hit the object hits the object, damage is caused due to the attack having the same ID.

9. The game system according to claim 8, wherein
in the damage calculation process,
when an attack having an ID that is different from the ID assigned to a past attack that has hit the object due to the attack hits the object, damage due to the attack having the different ID is forbidden to occur during a period of time from the past attack, and
when an attack having an ID that is the same as the ID assigned to a past attack that has hit the object due to the attack hits the object during the period of time, damage is caused due to the attack having the same ID.

10. The game system according to claim 8, wherein
further, a character control process of controlling a character that is the object in the virtual space is executed, and
in the damage calculation process, in an attack that is against the character and has an ID that is the same as the ID assigned to a past attack that it is determined that the character has successfully defended itself against using a defensive object with which the character is equipped, damage to the character due to the attack having the same ID is forbidden to occur.

11. The game system according to claim 8, wherein
further, a character control process of controlling a character that is the object equipped with a defensive object having a durability value that is reduced each time defense is successful against the attack in the virtual space, is executed, and
in the character control process, when an attack having an ID that is the same as the ID assigned to a past attack that it is determined that the character has successfully defended itself against using the defensive object hits the defensive object, a reduction in the durability value due to the attack having the same ID is forbidden to occur.

12. The game system according to claim 8, wherein
further, a character control process of controlling a character in the virtual space is executed,
in the attack generation process, when the character is caused to perform the attack using a combination weapon object obtained by combining a weapon object with an item object, in the attack an attack using the weapon object and an attack using the item object are generated, and the same ID is assigned to the attack using the weapon object and the attack using the item object, and
in the damage calculation process, when it is determined that one of the attack using the weapon object and the attack using the item object is successful, and damage is caused to the object due to the one attack, damage is further caused due to the other of the attack using the weapon object and the attack using the item object.

13. The game system according to claim 8, wherein
in the attack generation process,
a series of attacks that are a first attack, a second attack, and a third attack are generated according to a user's attack command input,
a first ID is assigned to the first attack according to the attack command input,
a second ID that is the same as the first ID is assigned to the second attack associated with the first attack at the time of the first attack or after the first attack occurs, and
a third ID that is the same as the second ID is assigned to the third attack associated with the second attack after the first attack occurs, at the time of the second attack, or after the second attack occurs, and
in the damage calculation process, when the attack having the first ID and/or the attack having the second ID hit the object, damage is caused due to the attack having the third ID.

14. A game system comprising:
one or more processors; and
one or more memories storing instructions that, when executed, cause the game system to perform operations including:
executing a character control process of controlling a character in a virtual space;
executing an attack generation process of causing the character to perform an attack using a weapon object that the character is allowed to carry; and
when the attack hits an object disposed in the virtual space, determining that the attack is successful, and executing a damage calculation process of calculating damage caused by the attack,
wherein
in the attack generation process, when the character is caused to perform the attack using a combination weapon object obtained by combining the weapon object with an item object, in the attack an attack using the weapon object and an attack using the item object are generated, and
in the damage calculation process, when it is determined that one of the attack using the weapon object and the attack using the item object is successful, and damage is caused to the object due to the one attack, damage is further caused due to the other of the attack using the weapon object and the attack using the item object.

15. A game apparatus comprising:
one or more processors; and
one or more memories storing instructions that, when executed, cause the game apparatus to perform operations including:
executing an attack generation process of generating at least one attack in a virtual space, and assigning an ID to each attack, based on a game process; and
when the attack hits an object in the virtual space, determining that the attack is successful, and executing a damage calculation process of calculating damage caused by the attack,
wherein
in the damage calculation process, when an attack having an ID that is the same as the ID assigned to a past attack that has hit the object hits the object, damage is caused due to the attack having the same ID.

16. The game apparatus according to claim 15, wherein
in the damage calculation process,
when an attack having an ID that is different from the ID assigned to a past attack that has hit the object due to the attack hits the object, damage due to the attack having the different ID is forbidden to occur during a period of time from the past attack, and
when an attack having an ID that is the same as the ID assigned to a past attack that has hit the object due to the attack hits the object during the period of time, damage is caused due to the attack having the same ID.

17. The game apparatus according to claim 15, wherein
further, a character control process of controlling a character that is the object in the virtual space is executed, and
in the damage calculation process, in an attack that is against the character and has an ID that is the same as the ID assigned to a past attack that it is determined that the character has successfully defended itself against using a defensive object with which the character is equipped, damage to the character due to the attack having the same ID is forbidden to occur.

18. The game apparatus according to claim 15, wherein
further, a character control process of controlling a character that is the object equipped with a defensive object having a durability value that is reduced each time defense is successful against the attack in the virtual space, is executed, and
in the character control process, when an attack having an ID that is the same as the ID assigned to a past attack that it is determined that the character has successfully defended itself against using the defensive object hits the defensive object, a reduction in the durability value due to the attack having the same ID is forbidden to occur.

19. The game apparatus according to claim 15, wherein
further, a character control process of controlling a character in the virtual space is executed,
in the attack generation process, when the character is caused to perform the attack using a combination weapon object obtained by combining a weapon object with an item object, in the attack an attack using the weapon object and an attack using the item object are generated, and the same ID is assigned to the attack using the weapon object and the attack using the item object, and
in the damage calculation process, when it is determined that one of the attack using the weapon object and the attack using the item object is successful, and damage is caused to the object due to the one attack, damage is further caused due to the other of the attack using the weapon object and the attack using the item object.

20. The game apparatus according to claim 15, wherein
in the attack generation process,
a series of attacks that are a first attack, a second attack, and a third attack are generated according to a user's attack command input,
a first ID is assigned to the first attack according to the attack command input,
a second ID that is the same as the first ID is assigned to the second attack associated with the first attack at the time of the first attack or after the first attack occurs, and
a third ID that is the same as the second ID is assigned to the third attack associated with the second attack after the first attack occurs, at the time of the second attack, or after the second attack occurs, and
in the damage calculation process, when the attack having the first ID and/or the attack having the second ID hit the object, damage is caused due to the attack having the third ID.

21. A game apparatus comprising:
one or more processors; and
one or more memories storing instructions that, when executed, cause the game apparatus to perform operations including:
executing a character control process of controlling a character in a virtual space;
executing an attack generation process of causing the character to perform an attack using a weapon object that the character is allowed to carry; and
when the attack hits an object disposed in the virtual space, determining that the attack is successful, and executing a damage calculation process of calculating damage caused by the attack,
wherein
in the attack generation process, when the character is caused to perform the attack using a combination weapon object obtained by combining the weapon object with an item object, in the attack an attack using the weapon object and an attack using the item object are generated, and
in the damage calculation process, when it is determined that one of the attack using the weapon object and the attack using the item object is successful, and damage is caused to the object due to the one attack, damage is further caused due to the other of the attack using the weapon object and the attack using the item object.

22. A game processing method for causing one or more processors of an information processing system to at least:
perform generation of at least one attack in a virtual space, and assigning an ID to each attack, based on a game process; and
when the attack hits an object in the virtual space, determine that the attack is successful, and perform damage calculation of the attack,
wherein
in the damage calculation, when an attack having an ID that is the same as the ID assigned to a past attack that has hit the object hits the object, damage is caused due to the attack having the same ID.

23. The game processing method according to claim 22, wherein
in the damage calculation,
when an attack having an ID that is different from the ID assigned to a past attack that has hit the object due to the attack hits the object, damage due to the attack having the different ID is forbidden to occur during a period of time from the past attack, and
when an attack having an ID that is the same as the ID assigned to a past attack that has hit the object due to the attack hits the object during the period of time, damage is caused due to the attack having the same ID.

24. The game processing method according to claim 22, wherein
further, control of a character that is the object is performed in the virtual space, and
in the damage calculation, in an attack that is against the character and has an ID that is the same as the ID assigned to a past attack that it is determined that the character has successfully defended itself against using a defensive object with which the character is equipped, damage to the character due to the attack having the same ID is forbidden to occur.

25. The game processing method according to claim 22, wherein
further, control of a character that is the object equipped with a defensive object having a durability value that is reduced each time defense is successful against the attack, is performed in the virtual space, and
in the control of the character, when an attack having an ID that is the same as the ID assigned to a past attack that it is determined that the character has successfully defended itself against using the defensive object hits the defensive object, a reduction in the durability value due to the attack having the same ID is forbidden to occur.

26. The game processing method according to claim 22, wherein
further, control of a character is performed in the virtual space,
in the generation of the at least one attack, when the character is caused to perform the attack using a combination weapon object obtained by combining a weapon object with an item object, in the attack an attack using the weapon object and an attack using the item object are generated, and the same ID is assigned to the attack using the weapon object and the attack using the item object, and
in the damage calculation, when it is determined that one of the attack using the weapon object and the attack using the item object is successful, and damage is caused to the object due to the one attack, damage is further caused due to the other of the attack using the weapon object and the attack using the item object.

27. The game processing method according to claim 22, wherein
in the generation of the at least one attack,
a series of attacks that are a first attack, a second attack, and a third attack are generated according to a user's attack command input,
a first ID is assigned to the first attack according to the attack command input,
a second ID that is the same as the first ID is assigned to the second attack associated with the first attack at the time of the first attack or after the first attack occurs, and
a third ID that is the same as the second ID is assigned to the third attack associated with the second attack after the first attack occurs, at the time of the second attack, or after the second attack occurs, and
in the damage calculation, when the attack having the first ID and/or the attack having the second ID hit the object, damage is caused due to the attack having the third ID.

28. A game processing method for causing one or more processors of an information processing system to at least:
control a character in a virtual space;
perform generation of an attack so as to cause the character to perform the attack using a weapon object that the character is allowed to carry; and
when the attack hits an object disposed in the virtual space, determine that the attack is successful, and perform damage calculation of the attack,
wherein
in the generation of the attack, when the character is caused to perform the attack using a combination weapon object obtained by combining the weapon object with an item object, in the attack an attack using the weapon object and an attack using the item object are generated, and
in the damage calculation, when it is determined that one of the attack using the weapon object and the attack using the item object is successful, and damage is caused to the object due to the one attack, damage is further caused due to the other of the attack using the weapon object and the attack using the item object.
